(19) United States
(12) Patent Application Publication
(10) Pub. No.: US 2025/0303721 A1
(43) Pub. Date: Oct. 2, 2025

(54) Method Of Manufacturing Liquid Ejecting Head

(71) Applicant: SEIKO EPSON CORPORATION, Tokyo (JP)

(72) Inventors: Atsushi MUTO, Shiojiri (JP); Hiroki MIYAJIMA, Matsumoto (JP); Shun KATSUIE, Matsumoto (JP)

(21) Appl. No.: 19/093,732

(22) Filed: Mar. 28, 2025

(30) Foreign Application Priority Data
Mar. 29, 2024 (JP) 2024-055434

(51) Int. Cl. B41J 2/16; B41J 2/045

(52) U.S. Cl. CPC B41J 2/1635; B41J 2/04536; B41J 2/04581; B41J 2202/21; B41J 2202/22

(57) ABSTRACT

A method of manufacturing a liquid ejecting head includes: first ranking and classifying a plurality of used head chips included in a first liquid ejecting head into a plurality of ranks based on characteristic information of each of the plurality of used head chips included in the first liquid ejecting head; and selecting used head chips to be embedded in the second liquid ejecting head among the plurality of used head chips so that the second liquid ejecting head includes a plurality of used head chips classified in different ranks in the first ranking and classifying. The second liquid ejecting head is manufactured by recycling part of the plurality of used head chips included in the first liquid ejecting heads by embedding the selected used head chips into the second liquid ejecting head.

### METHOD OF MANUFACTURING LIQUID EJECTING HEAD

The present application is based on, and claims priority from JP Application Serial Number 2024-055434, filed Mar. 29, 2024, the disclosure of which is hereby incorporated by reference herein in its entirety.

### BACKGROUND

### 1. Technical Field

The present disclosure relates to a method of manufacturing a liquid ejecting head.

### 2. Related Art

A known liquid ejecting apparatus includes a liquid ejecting head equipped with a plurality of head chips that eject liquid such as ink (see, for example, JP-A-2015-39804).

In related art, when a liquid ejecting head included in a liquid ejecting apparatus has almost reached its life span due to a failure or deterioration from use, the liquid ejecting apparatus is repaired by replacing the liquid ejecting head. A plurality of head chips are mounted on one liquid ejecting head. Thus, there has been a problem in that although the degree of failure or deterioration varies with each head chip, when some head chips are determined to be unusable or almost at the end of the life span, the whole liquid ejecting head is replaced, and usable head chips and head chips with low deterioration are also to be discarded.

### SUMMARY

The present disclosure can be implemented as a method of manufacturing a liquid ejecting head. The method of manufacturing a liquid ejecting head is for manufacturing a second liquid ejecting head by recycling part of a plurality of used head chips included in one or a plurality of first liquid ejecting heads, the method comprising: a first ranking and classification step for classifying the plurality of used head chips included in the one or a plurality of first liquid ejecting heads into a plurality of ranks based on characteristic information of each of the plurality of used head chips included in the one or a plurality of first liquid ejecting heads; a selection step for selecting one or a plurality of used head chips to be embedded in the second liquid ejecting head among the plurality of used head chips so that the second liquid ejecting head includes a plurality of used head chips classified in different ranks in the first ranking and classification step; and an embedding step for embedding the one or a plurality of the used head chips selected in the selection step into the second liquid ejecting head.

### BRIEF DESCRIPTION OF THE DRAWINGS

FIG. 1 is a top view illustrating a schematic configuration of a liquid ejecting apparatus used in a method of manufacturing a liquid ejecting head in an embodiment.

FIG. 2 is a side view illustrating a schematic configuration of the liquid ejecting apparatus.

FIG. 3 is an exploded perspective view illustrating the structure of a head unit.

FIG. 4 is an exploded perspective view illustrating the liquid ejecting head.

FIG. 5 is a cross-sectional view of a head chip included in the liquid ejecting head.

FIG. 6 is an explanatory diagram illustrating the functional configuration of the liquid ejecting apparatus.

FIG. 7 is an explanatory diagram illustrating a drive signal.

FIG. 8 is an explanatory diagram schematically illustrating a transitional flow since the head chips embedded in a head unit are collected until they are ranked and classified.

FIG. 9 is an explanatory graph schematically illustrating initial characteristic value of the head chip, and the subsequent temporal change.

FIG. 10 is an explanatory diagram illustrating the manner in which manufactured head chips are embedded in ejecting heads.

FIG. 11 is an explanatory table illustrating an example of data created and saved at the time of manufacturing of a head chip.

FIG. 12A is a flowchart illustrating steps of ranking and classifying collected used head chips.

FIG. 12B is an explanatory chart illustrating an example of a priority order in ranking and classification.

FIG. 13 is an explanatory diagram illustrating the manner in which a relay substrate of a head unit and a reading device are connected.

FIG. 14 is a flowchart illustrating a selection and assembly step for manufacturing a new liquid ejecting head.

FIG. 15 is an explanatory diagram illustrating the manner in which a new liquid ejecting head is manufactured.

FIG. 16 is a flowchart illustrating manufacturing steps for a liquid ejecting head in a second embodiment.

FIG. 17 is an explanatory diagram illustrating the manner of combination of used head chips.

FIG. 18 is an explanatory diagram illustrating the manner of another combination of used head chips.

FIG. 19 is an explanatory diagram illustrating the manner of another combination of used head chips.

FIG. 20 is a flowchart illustrating a process for measuring the state of a used head chip to be ranked and classified.

### DESCRIPTION OF EMBODIMENTS

In the following, an embodiment of a method of manufacturing a liquid ejecting head will be described with reference to the drawings. The drawings referred to are for the purpose of description. The embodiments described below provide only examples of embodiments, and are not intended to limit the content of the present disclosure. The components described below should not be interpreted as required components unless stated otherwise in the following.

### A. First Embodiment

### (A1) Overview of Liquid Ejecting Apparatus

A method of manufacturing a liquid ejecting head in a first embodiment will be described below. The manufacturing method in a first embodiment is for manufacturing a second liquid ejecting head by recycling part of a plurality of used head chips included in one or a plurality of first liquid ejecting heads. The first liquid ejecting heads are those liquid ejecting heads which have been embedded in a liquid ejecting apparatus or the like and used. The second liquid ejecting head is a liquid ejecting head that is manufactured by recycling at least part of the plurality of used head chips included in a first liquid ejecting head. Thus, before a description of the method of manufacturing a liquid ejecting head is given, first, a head unit including a plurality of liquid ejecting heads 31 each corresponding to the first liquid ejecting head and the configuration of a liquid ejecting apparatus including the head unit will be described. Note that in the present specification, delivering liquid through nozzles or the like to the outside is referred to as “ejection”. The ejection includes various manners in which a predetermined amount of liquid is output to the outside, such as injection, spray, nebulization and discharge, and intermittent outflow regardless of the type of liquid, the output time, and the number of times.

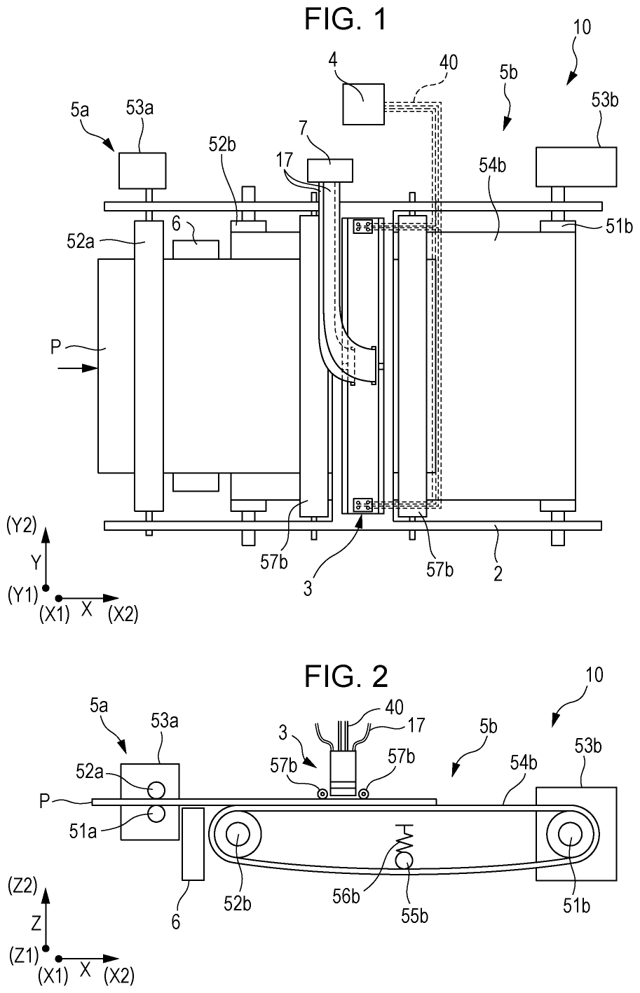

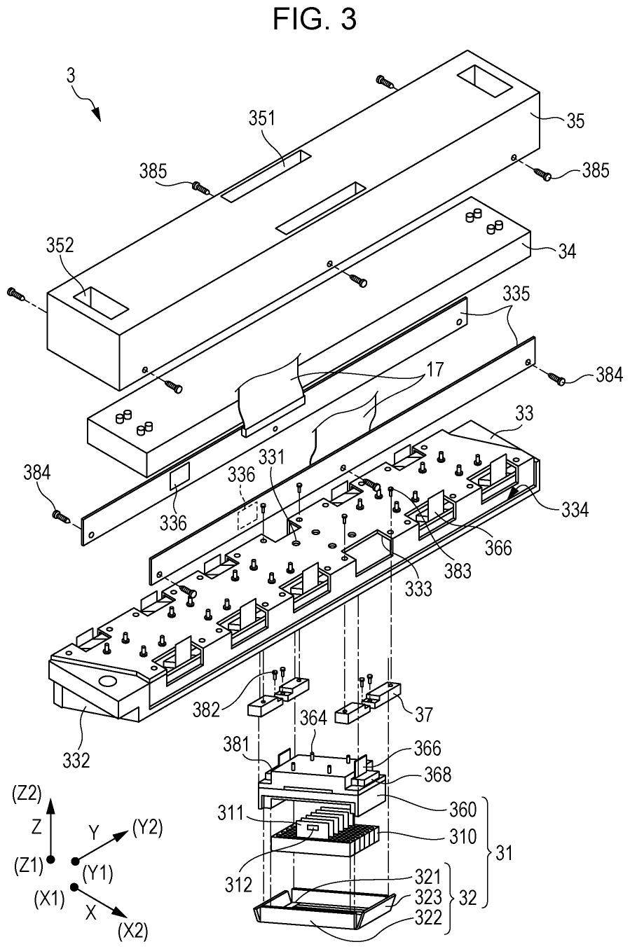

FIG. 1 is a top view illustrating a schematic configuration of a liquid ejecting apparatus 10. FIG. 2 is a side view illustrating a schematic configuration of the liquid ejecting apparatus 10. As illustrated in these figures, the liquid ejecting apparatus 10 presented in the present embodiment will be described using so-called a line ink jet printer as an example, which performs printing only by transporting a medium P on which ink is ejected. Note that the liquid ejecting apparatus 10 is not limited to a line ink jet printer, and may be so-called a serial ink jet printer which moves the head unit in synchronization with transport of the medium P.

In the following description, the transport direction in which the medium P is transported is referred to as a direction X, an upstream side of transport path for the medium P is referred to as X1 side, and a downstream side is referred to as X2 side. A description will be given assuming that in the in-plane direction of an ink landing surface where ink is landed on the medium P, the direction perpendicular to the direction X is referred to as a direction Y, one end of the liquid ejecting apparatus 10 in the direction Y is referred to as Y1 side, and the other end is referred to as Y2 side. In addition, a description will be given assuming that the direction which is perpendicular to both the direction X and the direction Y, and in which ink is ejected from a head unit 3 to the medium P is referred to as a direction Z, the ink from the head unit 3 is ejected from Z2 side to Z1 side of the direction Z. In the present embodiment, a description will be given assuming that the direction X, the direction Y, and the direction Z are axes perpendicular to each other; however, the components included in the liquid ejecting apparatus 10 are not necessarily disposed perpendicular to each other. These directions X, Y, Z are also shown as appropriate in other figures.

As illustrated in FIGS. 1 and 2, the liquid ejecting apparatus 10 includes an apparatus body 2, a head unit 3, a reservoir 4, a medium transport mechanism 5, and a maintenance mechanism 6. First, these primary components of the liquid ejecting apparatus 10 will be described.

The reservoir 4 reserves the ink to be supplied to the head unit 3. The reservoir 4 is fixed to the apparatus body 2. As the reservoir 4 to reserve the ink, e.g., an ink cartridge, a bag-shaped ink pack made of a flexible film, or an ink tank which can be refilled with ink is used. The ink reserved in the reservoir 4 is supplied to the head unit 3 through a supply pipe 40 such as a tube. The reservoir 4 may reserve ink of multiple colors such as black, cyan, magenta, yellow, red, and gray. Therefore, the reservoir 4 may include multiple ink cartridges, ink packs, or ink tanks corresponding to the colors of the reserved ink, and in addition, the supply pipe 40 may include multiple tubes corresponding to the colors of the ink reserved in the reservoir 4. Alternatively, the reservoir 4 may be mounted on the head unit 3.

The head unit 3 is supplied with a signal for controlling ejection of ink from a drive circuit substrate 7 through a cable 17. The head unit 3 then ejects the ink supplied from the reservoir 4 in an amount corresponding to the signal supplied from the drive circuit substrate 7, and at a timing corresponding to the signal supplied from the drive circuit substrate 7. The details of the head unit 3 will be described below.

The medium transport mechanism 5 includes a first transport section 5a and a second transport section 5b. The first transport section 5a is located on the X1 side of the head unit 3. At least part of the second transport section 5b is located on the X2 side of the head unit 3. The first transport section 5a and the second transport section 5b transport the medium P from the X1 side to the X2 side in the direction along the direction X.

The first transport section 5a includes a transport roller 51a, a driven roller 52a, and a drive motor 53a. The transport roller 51a is supplied with a driving force from the drive motor 53a. The transport roller 51a is rotationally driven in accordance with the driving force supplied from the drive motor 53a. The transport roller 51a nips the medium P with the driven roller 52a, and transports the medium P to the X2 side. The driven roller 52a may include a spring or the like (not illustrated) which presses the medium P against the transport roller 51a by a stress generated by an urging member.

The second transport section 5b includes a transport roller 51b, a driven roller 52b, a drive motor 53b, a transport belt 54b, a tension roller 55b, an urging member 56b, and a pressure roller 57b.

The transport roller 51b is located on the X2 side of the head unit 3 in the direction X. The transport roller 51b is supplied with a driving force from the drive motor 53b. The transport roller 51b is rotationally driven in accordance with the driving force supplied from the drive motor 53b. The driven roller 52b is provided at a position away from the transport roller 51b to the X1 side by a predetermined distance, and the transport belt 54b which is an endless belt is stretched between the driven roller 52b and the transport roller 51b. When the transport roller 51b is rotationally driven in accordance with the driving force supplied from the drive motor 53b, the transport belt 54b is driven by the transport roller 51b to transport the medium P fed by the driven roller 52a and the transport roller 51a to the downstream side, in other words, to the X2 side. The tension roller 55b is in contact with the inner peripheral surface of the transport belt 54b between the transport roller 51b and the driven roller 52b to apply a tensile force to the transport belt 54b with an urging force generated by the urging member 56b such as a spring.

The pressure roller 57b is provided on each of the X1 side and the X2 side of the head unit 3 on the Z2 side of the medium P. The medium P is nipped between the pressure roller 57b and the transport belt 54b, thus the posture of the medium P is maintained to be flat. In order to maintain the position and posture of the medium P more accurately, a flat platen may be provided on the Z1 side of the transport belt 54b immediately below (Z1 side) the head unit 3.

In the thus configured liquid ejecting apparatus 10, the medium P is transported from the X1 side to the X2 side in the direction along the direction X by driving the first transport section 5a and the second transport section 5b. Ink is ejected from the head unit 3 to the medium P transported at a predetermined timing. Consequently, the ink ejected from the head unit 3 lands on a desired position on the medium P so that a desired image is formed on the medium P.

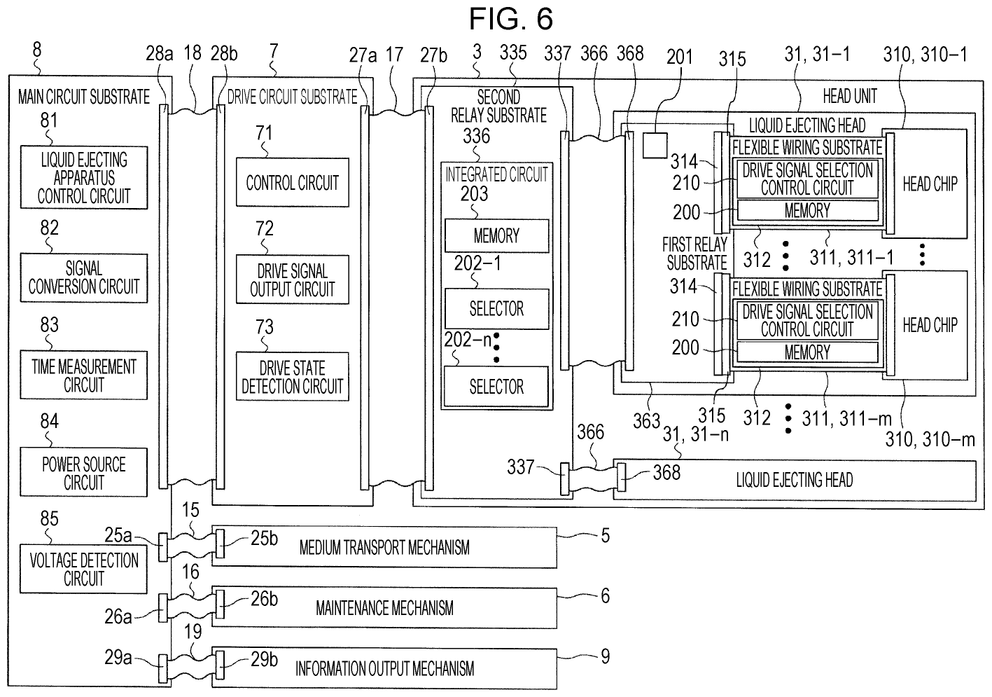

The maintenance mechanism 6 implements a maintenance function so that ink can be normally ejected by the head unit 3. The maintenance mechanism 6 is used to perform, for example, wiping, flushing, cleaning, and capping. The wiping is a process of wiping off a surface (hereinafter referred to as a nozzle surface) to remove ink and/or a slip of paper which have adhered to the nozzle surface by a wiping member WP (see FIG. 5) included in the maintenance mechanism 6, the surface from which ink is ejected by the head unit 3. The flushing is a process of ejecting ink through nozzles by driving the later-described piezoelectric element 60 with the nozzle surface opposed to a concave-shaped container (not illustrated) included in the maintenance mechanism 6 in order to maintain the viscosity of the ink reserved inside the reservoir 4 in an appropriate range, or to recover the viscosity of the ink to an appropriate state when abnormality occurs in the viscosity of the ink reserved inside the head unit 3. The cleaning process is suction cleaning or pressure cleaning, the suction cleaning for forcibly discharging ink to the outside through nozzles by applying a negative pressure into a capping space formed, for example, by covering the nozzle surface with a concave-shaped cap (not illustrated) included in the maintenance mechanism 6 with a negative pressure generation mechanism (not illustrated) such as a pump included in the maintenance mechanism 6 connected to the cap, the pressure cleaning for forcibly discharging ink to the outside through nozzles by pressurizing a flow path disposed upstream of the later-described pressure generation chamber 631 by a pressure mechanism (not illustrated) such as a pump included in the maintenance mechanism 6. In the present embodiment, a line ink jet printer is illustrated as the liquid ejecting apparatus 10, thus the maintenance mechanism 6 and the head unit 3 are provided at different positions, and the head unit 3 is moved to the position of the maintenance mechanism 6 by a head unit movement mechanism which is not illustrated to perform processes such as the above-mentioned wiping, flushing, and cleaning. The number of times of these processes can be treated as a piece of characteristic information of the head chip as described below.

### (A2) Structure of Head Unit

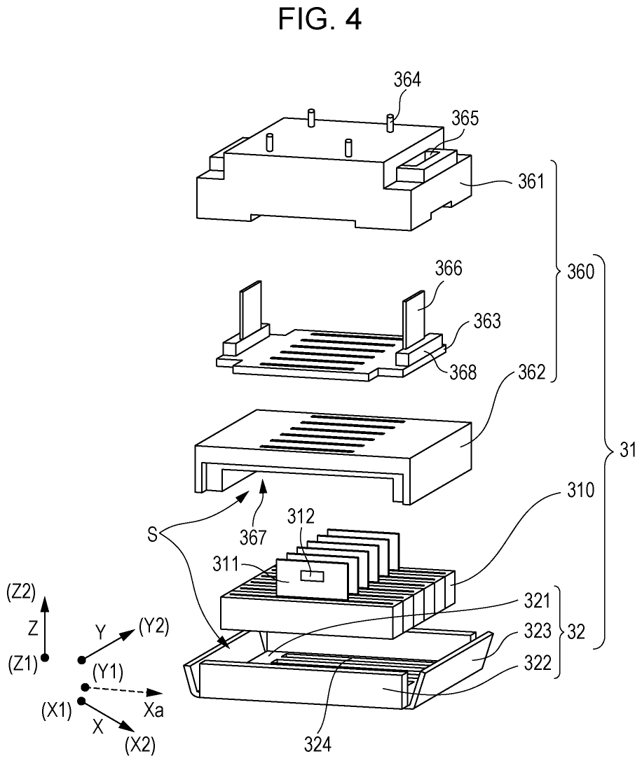

Next, the structure of the head unit 3 will be described. FIG. 3 is a partial exploded perspective view illustrating the structure of the head unit 3. As illustrated, the head unit 3 includes a plurality of liquid ejecting heads 31, a base member 33, a flow path member 34, and a cover member 35. FIG. 3 illustrates a case in which the head unit 3 includes six liquid ejecting heads 31; however, the number of liquid ejecting heads 31 included in the head unit 3 is not limited to six.

Each liquid ejecting head 31 includes a plurality of head chips 310, and a holding member 360 that holds these head chips. In the present embodiment, each liquid ejecting head 31 includes six head chips 310; however, the number of head chips 310 included in one liquid ejecting head 31 may be greater than six or less than six.

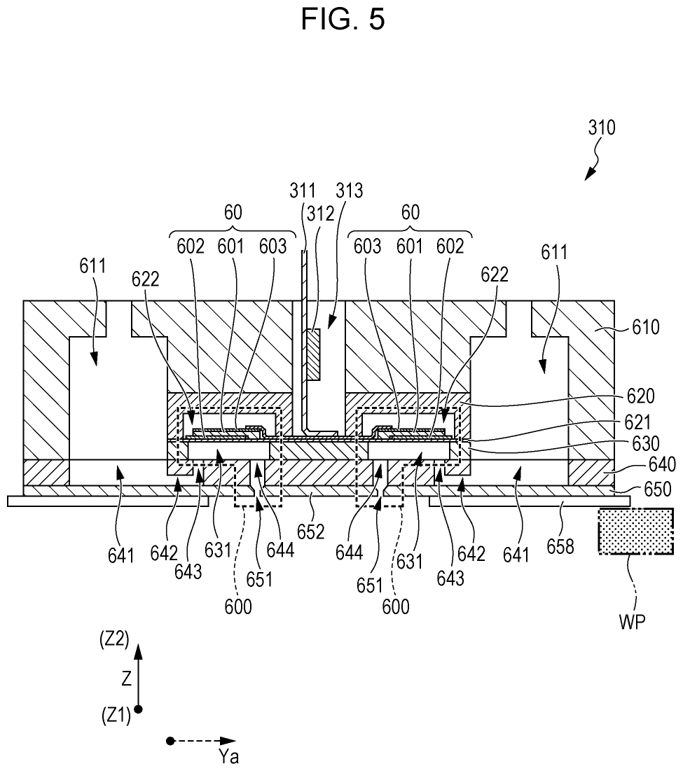

The detailed structure of the liquid ejecting head including six head chips 310 is illustrated in FIG. 4 which is an exploded perspective view. The plurality of head chips 310 included in the liquid ejecting head 31 have the same structure within a range of manufacturing tolerance. The internal structure of each head chip 310 is illustrated in FIG. 5. FIG. 5 is a cross-sectional view cut along Y-Z plane at the center of the head chip 310 illustrated in FIG. 4 in a longitudinal direction. As illustrated in FIG. 5, each head chip 310 includes a case 610, a protective substrate 620, a pressure chamber substrate 630, a flow path substrate 640, and a nozzle plate 650. In the head chip 310, the case 610, the protective substrate 620, the pressure chamber substrate 630, the flow path substrate 640, and the nozzle plate 650 are bonded together by an adhesive or the like. At least one of a plurality of adhesives for bonding these members comes into contact with the ink which flows through a flow path in the head chip 310.

The structure of the head chip 310 will be described mainly with reference to FIG. 5. The nozzle plate includes a plurality of nozzles 651 through which ink is ejected. Specifically, the nozzle plate 650 is provided with the plurality of nozzles 651 along a direction Xa which is the longitudinal direction of the head chip 310, as two nozzle rows in the direction along a direction Ya. Here, the direction Xa is a direction inclined with respect to the direction X which is the transport direction of the medium P, and the direction Ya is a direction crossing the direction Xa in X-Y plane defined by the direction X and the direction Y. In other words, the liquid ejecting head 31 is mounted on the head unit 3 so that the arrangement direction of the nozzles 651 included in the head chip 310 is inclined with respect to the direction X which is the transport direction of the medium P. Note that the nozzle rows formed by the nozzles 651 are not limited to two rows, and may be one row or three or more rows. In the nozzle plate 650, the Z1-side surface in which the nozzles 651 are open is called a nozzle surface 652. The head chip 310 has one nozzle plate 650.

The pressure chamber substrate 630 is located on the Z2 side of the nozzle plate 650. The pressure chamber substrate 630 includes a plurality of pressure generation chambers 631 which are partitioned by a partition wall or the like. Each pressure generation chamber 631 is located corresponding to a nozzle 651 included in the nozzle plate 650. Thus, the pressure chamber substrate 630 includes the pressure generation chambers 631 which are the same in number as the nozzles 651 provided in the nozzle plate 650. In addition, a plurality of pressure generation chambers 631 included in the pressure chamber substrate 630 are provided in parallel in the direction along the direction Xa. The rows of the pressure generation chambers 631 provided in parallel are located in two rows in the direction along the direction Ya.

The flow path substrate 640 is located on the Z2 side of the nozzle plate 650, and on the Z1 side of the pressure chamber substrate 630. In other words, the flow path substrate 640 is located between the nozzle plate 650 and the pressure chamber substrate 630 in the direction along the direction Z. The flow path substrate 640 includes a common flow path 641, a branch flow path 642, a communication flow path 643, and an individual flow path 644 for supplying the ink fed from the reservoir 4 to each of the plurality of nozzles 651.

The individual flow path 644 communicates with a nozzle 651 and a pressure generation chamber 631 which correspond to each other. The common flow path 641 is provided commonly with the plurality of pressure generation chambers 631 included in the pressure chamber substrate 630, and the plurality of nozzles 651 included in the nozzle plate 650. The common flow path 641 is supplied with ink from the reservoir 4. The ink supplied to the common flow path 641 is fed to the pressure generation chamber 631 through a branch flow path 642 and a communication flow path which are provided corresponding to the pressure generation chamber 631. In other words, the branch flow path 642 and the communication flow path 643 communicate with the pressure generation chamber 631 corresponding to the common flow path 641. In the thus configured flow path substrate 640, the ink supplied to the common flow path 641 is correspondingly branched to each of the plurality of pressure generation chambers 631 in the branch flow path 642, then is supplied to the pressure generation chamber 631 through the communication flow path 643.

A vibration plate 621 is bonded to the Z2-side surface of the pressure chamber substrate 630. The Z2-side surface of the vibration plate 621 is provided with a plurality of piezoelectric elements 60 corresponding to a plurality of pressure generation chambers 631. Specifically, each piezoelectric element 60 includes electrodes 602, 603 and a piezoelectric body layer 601, and on the Z2-side surface of the vibration plate 621, the electrode 602, the piezoelectric body layer 601, and the electrode 603 are layered in that order from the Z1 side to the Z2 side in the direction along the direction Z. One of the electrodes 602, 603 included in each piezoelectric element 60 is formed as a common electrode for supplying a signal having a common voltage value to the piezoelectric element 60, and the other of the electrodes 602, 603 is formed as an individual electrode for supplying a signal having an individual voltage value to each piezoelectric element 60. Note that in the present embodiment, a description will be given assuming that the electrode 602 is an individual electrode, and the electrode 603 is a common electrode; however, this is not always the case. The electrode 602 which is an individual electrode is supplied with a drive signal COM, and the electrode 603 which is a common electrode is supplied with a reference voltage signal indicating a reference potential Vbs of the drive signal COM.

In the thus configured piezoelectric element 60, the piezoelectric body layer 601 is deformed according to a potential difference occurred between the electrode 602 and the electrode 603. In other words, the piezoelectric element 60 is driven according to the potential difference between the voltage value of a signal supplied to the electrode 602 and the voltage value of a signal supplied to the electrode 603. The vibration plate 621 is displaced by the piezoelectric element 60 being driven. When the vibration plate 621 is displaced to the Z2 side, the internal pressure of the pressure generation chamber 631 decreases. As a result, the pressure generation chamber 631 is supplied with ink from the common flow path 641 through the branch flow path 642 and the communication flow path 643. On the other hand, when the vibration plate 621 is displaced to the Z1 side, the internal pressure of the pressure generation chamber 631 increases. As a result, the ink reserved in the pressure generation chamber 631 is ejected through the nozzle 651 via the individual flow path 644. Here, the configuration including the piezoelectric element 60, the pressure generation chamber 631, the individual flow path 644, and the nozzle 651 is called an ejector 600 that ejects ink from the head chip 310.

The protective substrate 620 is located on the Z2 side of the vibration plate 621. The protective substrate includes a held section 622 that forms a space for protecting the piezoelectric element 60. The space formed by the held section 622 has a sufficient size for the displacement caused by the drive of the piezoelectric element 60.

The case 610 is located on the Z2 side of the flow path substrate 640 and the protective substrate 620. The case 610 includes a manifold 611 that communicates with the common flow path 641 of the flow path substrate 640. The manifold 611 is a space for reserving the ink to be supplied to the plurality of nozzles 651, and is provided continuously over the plurality of nozzles 651 and the plurality of pressure generation chambers 631. The ink supplied to the manifold 611 is fed to the common flow path 641. In other words, the common flow path 641 and the manifold 611 are a common liquid chamber that communicates with the plurality of nozzles 651. The common liquid chamber extends in a longitudinal direction which is the direction Xa in which the plurality of nozzles 651 are arranged.

In the liquid ejecting head 31, the protective substrate 620 and the case 610 are provided with a through-hole 313 that penetrates therethrough in the direction along the direction Z. A flexible wiring substrate 311 is inserted into the through-hole 313. One end of the flexible wiring substrate 311 is electrically connected to a lead electrode which is drawn from the electrodes 602, 603 of the piezoelectric element 60. In other words, a signal for driving the piezoelectric element 60 propagates through the flexible wiring substrate 311. An integrated circuit 312 is implemented on the flexible wiring substrate 311. The integrated circuit 312 receives input of the signal for driving the piezoelectric element 60, which propagates through the flexible wiring substrate 311. The integrated circuit 312 controls, based on the input signal, the timing when the signal for driving the piezoelectric element 60 is supplied to the electrode 602. Thus, the timing when the piezoelectric element 60 is driven, and the amount of drive of the piezoelectric element 60 are controlled. Therefore, a predetermined amount of ink is ejected from the ejector including the piezoelectric element 60 at a predetermined timing. Note that a water repellent film 658 is formed outside the nozzle plate 650, and for example when the surface of the head chip 310 becomes dirty, the nozzle plate 650 is wiped by the wiping member WP.

A pressure fluctuation to cause ink ejection through the nozzles 651 is generated by the piezoelectric element 60 including the electrode 603, the piezoelectric body layer 601 and the electrode 602; one pressure generation chamber 631; and the vibration plate 621 in the head chip 310. The piezoelectric element 60, the pressure generation chamber 631, and the vibration plate 621 together are also called a segment. The head chip 310 includes such segments as many as the number of the nozzles 651. The segment has various characteristic amounts related to ejection of liquid. The characteristic amounts include, for example, the natural frequency of the segment, the weight of the ink droplets ejected through the nozzles 651, the speed of the ink droplets ejected through the nozzles 651, and the displacement amount of the vibration plate 621 of the segment.

The natural frequency of the segment can be measured by publicly known device and method. For example, a publicly known measuring instrument called an impedance analyzer is used to input a specific Sine wave to the segment, and the impedance is measured. The impedance of the segment is changed by changing the frequency of the Sine wave to be input. The frequency of the input Sine wave having a peak of the impedance can be measured as the natural frequency of the segment. The natural frequency is a value correlated with a natural frequency cycle Tc of the liquid in the pressure generation chamber 631.

The weight of the ink droplets ejected through the nozzles 651 can be measured by publicly known device and method. For example, a drive signal COM including a specific drive waveform (drive waveform as a reference) which enables ejection of liquid droplets is applied to the piezoelectric element 60 to cause a certain number of liquid droplets to be ejected to a receiving container. The weight of the ink droplets ejected through the nozzles 651 can be determined by measuring a weight change of the receiving container, or a weight change of the reservoir 4 which is the supply source of ink. For the measurement, a highly accurate weight scale such as an electric scale can be used.

The displacement amount of the vibration plate 621 of the segment refers to the difference between a maximum value and a minimum value of the displacement of a vibration section where piezoelectric strain occurs due to the piezoelectric element 60. The displacement amount of the vibration plate 621 of the segment is simply called the displacement amount of the segment. The displacement amount of the segment can be measured by publicly known device and method. For example, the speed of the vibration plate 621 which is moving due to vibration can be measured using a Doppler vibrometer which utilizes the occurrence of a wavelength difference in a round trip of a laser radiated to and reflected from the vibration plate 621 which is vibrating, thus the displacement amount of the vibration plate 621 can be measured by integrating the speed.

The natural frequency of these segments, the weight of the ink droplets ejected through the nozzles 651, the speed of the ink droplets ejected through the nozzles 651, and the displacement amount of the vibration plate 621 can be used in the later-described ranking and classification of head chip. Note that in a plurality of segments included in one head chip 310, the above-mentioned measurement values such as the natural frequency may be different from each other. In this case, ranking and classification may be performed based on the average value or the mode of the measurement values of the plurality of segments included in one head chip 310.

The thus configured head chip 310 is held by the holding member 360 in the liquid ejecting head 31. As illustrated in FIG. 4, the holding member 360 includes: the flow path member 361 in common with the plurality of head chips 310; a holder 362 that holds the plurality of head chips 310; and a first relay substrate 363 electrically connected to at least two of the head chips 310. The first relay substrate 363 in the present embodiment is electrically connected to all head chips 310 included in the liquid ejecting head 31.

Inside the flow path member 361, flow paths are provided for supplying the ink fed from the reservoir 4 to the head chips 310 through the flow path member 34. Each flow path communicates with an ink feeder 364 provided on the Z2-side surface of the flow path member 361. In other words, the ink supplied from the reservoir 4 is fed to the flow path member 361 via the ink feeder 364. Note that the flow paths provided inside the flow path member 361 are provided corresponding to respective ink feeders 364. FIG. illustrates the flow path member 361 including four ink feeders 364; however, this is not always the case. Inside the flow path member 361, a filter may be provided for removing foreign materials such as dust and air bubbles contained in the supplied ink.

Both ends of the flow path member 361 along the direction X are provided with cable insertion holes 365 penetrating in the direction Z. Cables 366 are inserted into the cable insertion holes 365, the cables 366 being electrically connected to the later-described first relay substrate 363 via connectors 368. Here, the connectors 368 are detachably connected to the respective cables 366, and electrically connected to a plurality of terminals respectively corresponding to a plurality of wires included in the cables 366.

The holder 362 is located on the Z1 side of the flow path member 361, and fixed to the flow path member 361 by a screw 381 illustrated in FIG. 3. The holder 362 includes a held section 367. The held section 367 is a groove-shaped space that is continuous in the direction Y on the Z1-side surface of the holder 362, and is open in both lateral surfaces in the direction Y. In the held section 367, the plurality of head chips 310 are bonded by an adhesive which is not illustrated. Consequently, the plurality of head chips 310 are held in the holding member 360.

Inside the holder 362, flow paths (not illustrated) are provided which communicate with the flow paths provided inside the flow path member 361. The ink fed from the ink feeders 364 is supplied to the head chips 310 through the flow paths provided inside the flow path member 361 and the flow paths provided inside the holder 362. In other words, the holder 362 is a flow path member in common with the plurality of head chips 310.

The first relay substrate 363 is located between the flow path member 361 and the holder 362. The first relay substrate 363 is electrically connected to the flexible wiring substrate 311 included in each head chip 310. In addition, the first relay substrate 363 is provided with the connector 368. In the thus configured first relay substrate 363 propagates a signal input through the cables electrically connected to the respective connectors 368 to a corresponding head chip 310, and outputs a signal output from each head chip 310 through the flexible wiring substrate 311 to the outside of the liquid ejecting head 31 through the connectors 368 and the cables 366. The first relay substrate 363 includes a memory 201.

The above-described liquid ejecting head 31 includes a cover 32 that covers the plurality of head chips between the cover 32 and the holder 362. In other words, the plurality of head chips 310 are disposed inside a housing space S that is the space defined by the held section 367 of the holder 362 and the cover 32. Thus, the possibility of adhering of ink droplets floating inside the liquid ejecting apparatus 10 to the head chips 310 is reduced. In other words, the cover 32 protects the head chips 310 included in the liquid ejecting head 31 against ink droplets.

The cover 32 is provided on the Z1 side, that is, the nozzle surface 652 side of the plurality of head chips provided in the liquid ejecting head 31. As illustrated in FIG. 4, the cover 32 includes a base section 321 and extension sections 322, 323. The base section 321 is a plate-like member provided on the nozzle surface 652 side of the head chips 310 covered by the cover 32. The cover 32 forms a space by the extension sections 322, 323 together with the base section 321, and the holder 362 is inserted into the formed space. The base section 321 is bonded to the Z1-side surface of the holder 362 by an adhesive which is not illustrated.

The base section 321 has a plurality of openings 324. Each opening 324 corresponds to a corresponding one of the head chips 310, and exposes the plurality of nozzles 651 included in the corresponding head chip 310 to the outside. Thus, the ink ejected from each head chip 310 lands on the medium P without being interfered by the cover 32.

Returning to FIG. 3, the plurality of liquid ejecting heads 31 are fixed to the base member 33. The base member 33 internally includes a housing section 332 having a space opened on the Z1 side. The plurality of liquid ejecting heads 31 are housed and held in the space. Specifically, the liquid ejecting heads 31 are housed in the housing section 332 of the base member 33 so that the nozzle surface 652 side of the liquid ejecting heads 31 projects from the housing section 332 to the Z1 side. In this situation, each of the plurality of liquid ejecting heads 31 is housed in the housing section 332 so that the nozzle rows located on the nozzle surface 652 are in the direction along the direction Xa inclined with respect to the direction X.

When the liquid ejecting heads 31 are housed in the base member 33, the liquid ejecting heads 31 are fixed to the base member 33 via spacers 37. The spacers 37 are fixed to the Z2-side surface of the liquid ejecting heads 31 by screws 382, and are fixed to the Z1-side surface of the base member 33 by screws 383. In short, the liquid ejecting heads 31 are fixed to the base member 33 via the spacers 37. As described above, the spacers 37 fixed to the liquid ejecting heads 31 by the screws 382 is fixed to the base member 33 by the screw 383, thereby making it possible to facilitate attachment and detachment of the liquid ejecting heads 31 to and from the base member 33. Note that the spacers 37 and the liquid ejecting heads 31 are not necessarily fixed using the screws 382.

The base member 33 has supply holes 331 penetrating in the direction Z. The ink feeders 364 included in the liquid ejecting heads 31 fixed to the base member 33 are inserted into the supply holes 331. The base member 33 has openings 333 penetrating in the direction Z. The cables 366 included in the head unit 3 fixed to the base member 33 are inserted into the respective openings 333.

Of the housing section 332, the outer peripheries on both sides opposed to each other in the direction along the direction X are respectively provided with steps 334 opened on the Z2 side. The second relay substrate 335 is housed in each of the steps 334. The second relay substrate is electrically connected to cables 366 respectively corresponding to the plurality of liquid ejecting heads 31 guided from the plurality of openings 333. Thus, signals input to the plurality of liquid ejecting heads 31, and signals output from the plurality of liquid ejecting heads propagate through the second relay substrate 335.

An integrated circuit 336 is implemented on the second relay substrate 335. In the head unit 3 illustrated in FIG. 3, the case is shown in which two second relay substrates 335 are provided, each of which includes the integrated circuit 336; however, the integrated circuit 336 may be provided in only one of the two second relay substrates 335, and the head unit 3 may include only one second relay substrates 335. Two second relay substrates are each fixed to the housing section 332 by a screw 384.

Each second relay substrate 335 is connected to the cable 17 which is electrically connected to the drive circuit substrate 7 fixed to the apparatus body 2. Thus, various signals generated in the drive circuit substrate 7 are input to the head unit 3. The electrical wiring between each head chip 310, the integrated circuit 312, the first relay substrate 363 and the second relay substrate 335 will be described later.

The flow path member 34 is provided on the Z2 side of the base member 33. The flow path member 34 is a flow path member in common with the plurality of liquid ejecting heads 31, and distributes and supplies the ink fed from the reservoir 4 to each of the plurality of liquid ejecting heads 31. Inside the flow path member 34, a flow path (not illustrated) is provided for supplying the ink fed from the reservoir 4 to the plurality of liquid ejecting heads 31. The flow path provided inside the flow path member 34 communicates with the supply pipe 40 connected to the reservoir 4, and communicates with the ink feeders 364 of the liquid ejecting heads 31. Thus, the ink fed from the reservoir 4 is supplied to a corresponding liquid ejecting head 31.

The cover member 35 is provided on the Z2 side of the flow path member 34. The cover member 35 is a box-shaped member that covers the flow path member 34, and the second relay substrate 335. The cover member 35 is provided with openings 351 for inserting the cables 17, and openings for inserting the supply pipes 40. The cover member 35 is fixed to the housing section 332 of the base member 33 by screws 385.

As described above, the head unit 3 is to be embedded in the liquid ejecting apparatus 10 that ejects ink to the medium P, and includes the plurality of liquid ejecting heads 31, and each liquid ejecting head 31 includes the plurality of head chips 310.

### (A3) Functional Configuration of Liquid Ejecting Apparatus

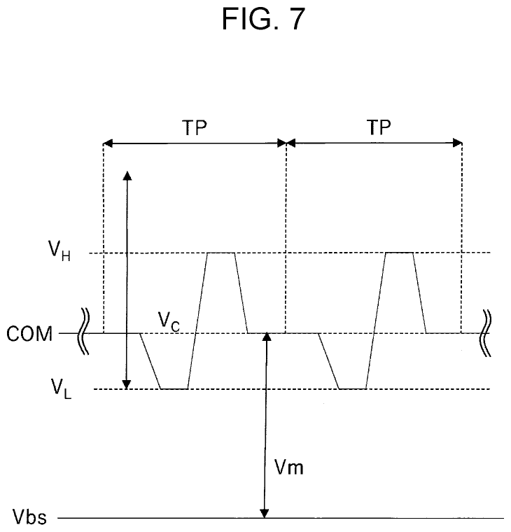

Next, the functional configuration of the liquid ejecting apparatus 10 will be described. FIG. 6 is an explanatory diagram illustrating the functional configuration of the liquid ejecting apparatus 10. As illustrated in FIG. 6, the liquid ejecting apparatus 10 includes the head unit 3, the medium transport mechanism 5, the maintenance mechanism 6, the drive circuit substrate 7, a main circuit substrate 8, and an information output mechanism 9. Since the configuration of the medium transport mechanism 5 has been already described, the head unit 3, the maintenance mechanism 6, the drive circuit substrate 7, and the main circuit substrate 8 will be briefly described sequentially below.

The hardware configuration of the head unit 3 has been already described in detail. The electrical configuration inside the head unit 3 will be described with reference to FIG. 6. As illustrated, the head unit 3 includes n liquid ejecting heads 31, and each of the liquid ejecting heads 31 includes m head chips 310. That is, a description will be given assuming that the head unit 3 includes n×m head chips 310 in total. Each of n and m is an integer greater than 1. In the liquid ejecting head 31, each head chip 310 is connected to the first relay substrate via m flexible wiring substrates 311. The connection between the first relay substrate 363 and each head chip 310 is implemented by connecting a connector 315 provided at the other end of each flexible wiring substrate 311 to a connector 314 of the first relay substrate 363. The connector 315 and the connector 314 are detachably connected.

When the n liquid ejecting heads 31 are distinguished in the following description, they may be denoted as the liquid ejecting heads 31-1 to 31-n, and similarly, when the m head chips 310 and flexible wiring substrates 311 are distinguished, they may be denoted as the head chips 310-1 to 310-m and the flexible wiring substrates 311-1 to 311-m. When it is not necessary to distinguish each of the liquid ejecting heads 31-1 to 31-n, the flexible wiring substrates 311-1 to 311-m, and the head chips 310-1 to 310-m, these components are simply called the liquid ejecting head 31, the flexible wiring substrate 311, and the head chip 310.

Each flexible wiring substrate 311 is provided with the integrated circuit 312. The integrated circuit 312 includes a memory 200, and a drive signal selection control circuit 210. The memory 200 stores data such as a usage history of the head chip 310 including the memory 200. The drive signal selection control circuit 210 selects a signal to the plurality of piezoelectric elements 60 included in the head chip 310, and causes liquid, that is, ink herein to be ejected through a desired nozzle 651 among the plurality of nozzles 651 included in the head chip 310.

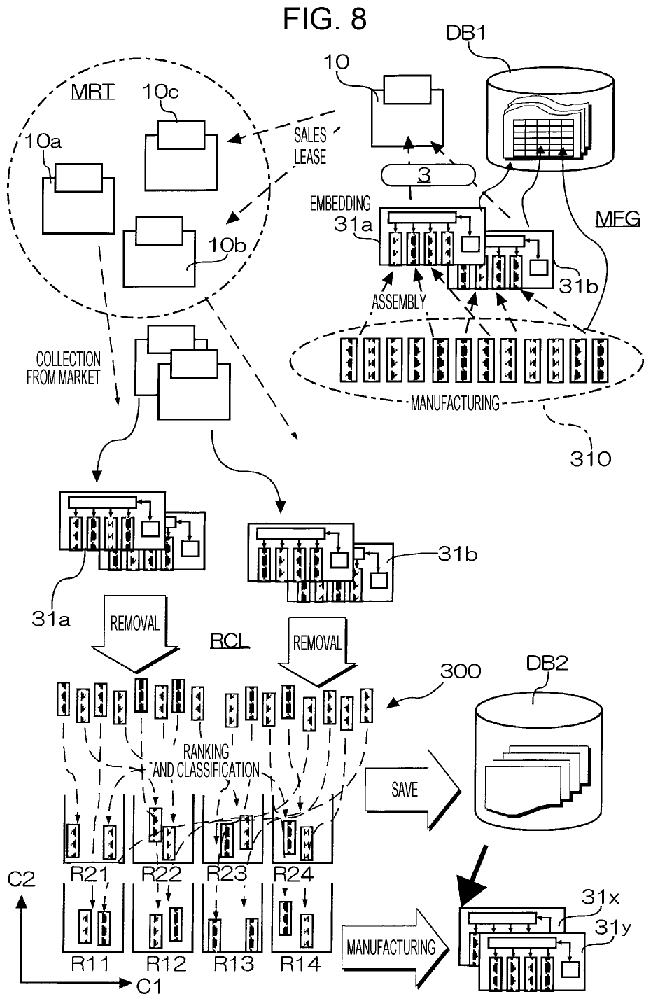

The configuration of the drive signal selection control circuit 210 is schematically illustrated in FIG. 6. As illustrated, the head chip 310 is provided with the piezoelectric element 60 that causes a pressure change for ejection corresponding to each of the plurality of nozzles 651. Upon receiving the drive signal COM via the drive signal selection control circuit 210, the piezoelectric element 60 expands or contracts along the Z direction according to a voltage applied. The drive signal COM and the reference voltage signal are illustrated in FIG. 7.

The drive signal selection control circuit 210 includes a plurality of switching elements respectively corresponding to the plurality of piezoelectric elements 60. For each print cycle TP, each switching element selects whether the drive signal COM is supplied to the individual electrode of a corresponding piezoelectric element 60, based on a clock signal, a latch signal, a change signal, and a print data signal which are not illustrated.

As illustrated in FIG. 7, the drive signal COM is, for example, a trapezoidal wave, and includes a time period during which a lowest potential VL is maintained, a time period during which a highest potential VH is maintained, a time period during which an intermediate potential VC between the lowest potential VL and the highest potential VH is maintained, and multiple time periods having a slope and connecting the time periods during which those potentials are maintained. The reference voltage signal is a signal that continues to be a constant reference potential Vbs smaller than the lowest potential VL. While the power source is supplied to the liquid ejecting head 31, in the time period during which liquid is not ejected through the nozzles 651, the intermediate potential VC of the drive signal COM is constantly applied to the individual electrode of the piezoelectric element 60, and the reference potential Vbs of the reference voltage signal is applied to the common electrode. Thus, a reference voltage Vm of the drive signal COM, which is the potential difference between the intermediate potential VC of the drive signal COM and the reference voltage signal Vbs has an effect on the deformation amount of the piezoelectric element 60 and temporal change in deformation characteristics. Therefore, the magnitude of the reference voltage Vm may be treated as one of pieces of characteristic information of the head chip 310. In addition, the ambient temperature of the head chip can be treated as characteristic information. The ambient temperature of the head chip 310 may be detected by a temperature sensor provided in the integrated circuit 312 or the like; however, the temperature in the housing of the liquid ejecting apparatus 10 or the temperature around the head chip 310 may be treated as the ambient temperature. A technique for storing the reference voltage Vm and the ambient temperature in the memory 200 of the head chip 310, and treating them as the characteristic information will be described below.

A signal from the head chip 310, and the drive signal COM to the head chip 310 are aggregated into the first relay substrate 363. The n first relay substrates 363 are connected to the second relay substrates 335 by the cables 366. The cables 366 are connected to the respective connectors 368 provided in the first relay substrates 363 and connectors 337 provided in the second relay substrates to electrically connect both substrates. Each second relay substrate 335 is provided with the integrated circuit 336. The integrated circuit 336 includes a memory 203, and n selectors 202. The n selectors 202 are provided respectively corresponding to the liquid ejecting heads 31-1 to 31-n. The selectors 202 receive input of a print data signal, a memory control signal, a latch signal, and a change signal which are input from the drive circuit substrate 7. According to the logic level of the input latch signal and change signal, each selector 202 selects whether a print data signal, a latch signal, and a change signal are output to the liquid ejecting head 31, or a memory control signal, a latch signal, and a change signal are output to the memory 200 of the flexible wiring substrate 311.

The head unit 3 described above is electrically connected to the drive circuit substrate 7 via the second relay substrate 335. The second relay substrate 335 and the drive circuit substrate 7 are connected through the cable 17. The cable 17 is connected at one end to a connector 27b provided in the second relay substrate 335, and is connected at the other end to a connector 27a provided in the drive circuit substrate 7, thus relays the exchange of signals of both sides.

The drive circuit substrate 7 includes a control circuit 71, a drive signal output circuit 72, and a drive state detection circuit 73. The control circuit 71 outputs a memory control signal for controlling the memory 203 included in the second relay substrate 335. The control of the memory 203 includes a reading process of reading information stored in the memory 203, and a writing process of writing information to the memory 203. The control circuit 71 generates a drive data signal that defines the voltage waveform of the drive signal COM for driving the piezoelectric element 60, and outputs the drive data signal to the drive signal output circuit 72. The drive signal output circuit 72 amplifies the voltage waveform defined by each drive data signal.

The drive state detection circuit 73 generates an ejector state signal based on the residual vibration signal input from the head chip 310 via the first relay substrate and the second relay substrate 335, the ejector state signal indicating the state of a corresponding ejector 600. The drive state detection circuit 73 outputs the ejector state signal to the control circuit 71. The control circuit determines based on the input ejector state signal whether a wiping process, a flushing process, or a cleaning process is performed by the maintenance mechanism 6, generates an operation information signal indicating a determination result, and outputs the operation information signal to a liquid ejecting apparatus control circuit 81 through the cable 18.

The main circuit substrate 8 includes the liquid ejecting apparatus control circuit 81, a signal conversion circuit 82, a time measurement circuit 83, a power source circuit 84, and a voltage detection circuit 85. The main circuit substrate 8 is provided with a connector 25a, a connector 26a, a connector 28a, and a connector 29a. The main circuit substrate 8 is connected to the drive circuit substrate 7 through the cable 18 connected to the connector 28a, connected to the medium transport mechanism 5 through the cable 15 connected to the connector 25a, connected to the maintenance mechanism 6 through the cable 16 connected to the connector 26a, and connected to the information output mechanism 9 through the cable 19 connected to the connector 29a. The substrates and mechanisms at connection destination are provided with the connectors 28b, 25b, 26b, and 29b to which the other ends of the cables 18, 15, 16, and 19 are connected. The connectors shown in the present specification are not limited to a specific type as long as the connectors has a structure that allows wiring members to be electrically connected detachably without using joining such as conductive adhesive or soldering. In the above-mentioned connector 314 and connector 315, one is a convex connector, and the other is a concave connector, and the connectors are electrically connected detachably by inserting and removing the convex connector into and from the concave connector. In this manner, regarding a connector other than the connectors 314, 315, a configuration may be used in which the connector is connected to another connector.

The liquid ejecting apparatus control circuit 81 exchanges signals with the components provided in the liquid ejecting apparatus 10, and controls the operation of the components. For example, the liquid ejecting apparatus control circuit 81 exchanges an instruction signal for transport of the medium P, and transport information on the transported medium P with the medium transport mechanism 5. In addition, the liquid ejecting apparatus control circuit exchanges a control signal for controlling the operation of the maintenance mechanism 6 with the maintenance mechanism 6. Similarly, the liquid ejecting apparatus control circuit 81 exchanges a control signal for controlling the operation of the information output mechanism 9 with the information output mechanism 9. In addition, the liquid ejecting apparatus control circuit 81 receives input of an image data signal from an external device such as a host computer provided outside the liquid ejecting apparatus 10, and after processing the image data signal as necessary, outputs the processed image data signal to the signal conversion circuit 82. The signal conversion circuit 82 converts the input image data signal to an image signal corresponding to the ink color used in the liquid ejecting apparatus 10, and outputs the image signal to the drive circuit substrate 7.

The power source circuit 84 receives input of an external commercial power source. The power source circuit converts the input external commercial power source to e.g., 42V direct current voltage to output the DC voltage. The direct current voltage output from the power source circuit 84 is input to the voltage detection circuit 85, and also used as the power source voltage for each component of the liquid ejecting apparatus 10. The voltage detection circuit 85 detects, based on the voltage value of the direct current voltage, whether the power source is normally supplied to the liquid ejecting apparatus 10. The voltage detection circuit 85 generates a voltage detection signal at a logic level corresponding to a detection result, and outputs the voltage detection signal to the time measurement circuit 83. For example, when the voltage value of the direct current voltage is out of a predetermined range, the voltage detection circuit 85 outputs an L level voltage detection signal to the time measurement circuit 83, and when the voltage value falls within the predetermined range, the voltage detection circuit 85 outputs a H level voltage detection signal VDET to the time measurement circuit 83. The time measurement circuit 83 determines, based on the voltage detection signal, whether the power source voltage is supplied to the liquid ejecting apparatus 10. When the power source voltage is determined to be supplied to the liquid ejecting apparatus 10 based on the voltage detection signal, the time measurement circuit 83 generates and outputs elapsed time information to the liquid ejecting apparatus control circuit 81. The elapsed time information is used to count the operation time of the liquid ejecting apparatus 10, and eventually of the head chip 310.

The information output mechanism 9 outputs various information to a user of the liquid ejecting apparatus 10. The liquid ejecting apparatus control circuit 81 generates a control signal for controlling the operation of the information output mechanism 9, and outputs the control signal to the information output mechanism 9 through the cable 19 connected to the connector 29a. The information output mechanism 9 includes, for example, a display for indication. The display for indication displays various information such as information indicating the operating state of the liquid ejecting apparatus 10, information indicating the operating state of the maintenance mechanism 6, information related to the usage history of the head unit 3, and warning information. The information output mechanism 9 may be configured to inform a user of various information, and may also inform a user of information, for example, by sound, light and the like.

### (A4) Cycle of Reuse of Head Chip

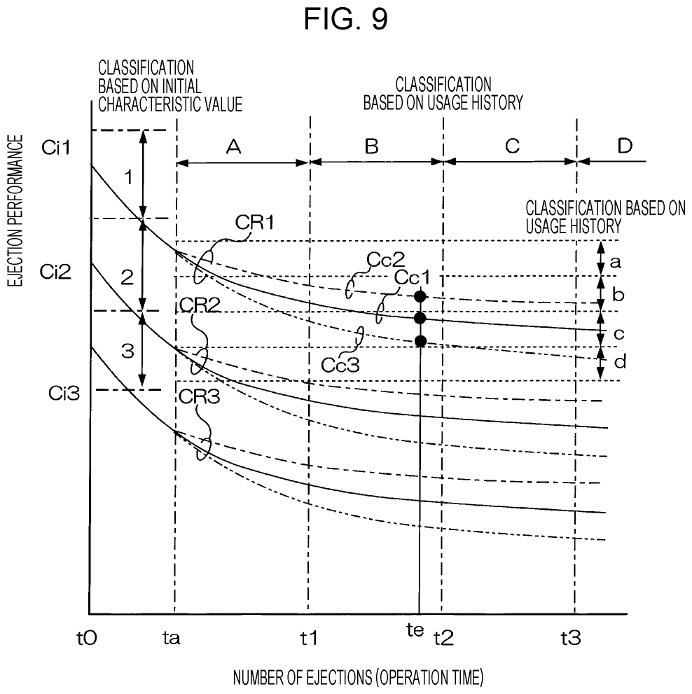

As described above, the head unit 3 embedded in the liquid ejecting apparatus 10 includes the plurality of liquid ejecting heads 31, and the plurality of head chips are further embedded in each liquid ejecting head 31. To describe the method of manufacturing a liquid ejecting head in the present embodiment, the cycle of a new head chip from manufacturing, market debut, collection, and recycle will be briefly explained with reference to FIG. 8. The terms used for description are based on the following definitions.
Head Chip 310: a head chip with no usage history and a head chip with a usage history, which has been used in a product until collected.
Used Head Chip 300: a collected head chip with a usage history. A head chip included in a collected product is called a used head chip 300 even though the head chip is mounted on a head unit 3 or a liquid ejecting head 31.
First Liquid Ejecting Head 31: a liquid ejecting head from which a used head chip 300 to be recycled is removed. In the above description of the hardware configuration, the term, liquid ejecting head 31 has been consistently used; however, a liquid ejecting head from which a used head chip is removed for recycle is called a first liquid ejecting head to distinguish it from a liquid ejecting head to be manufactured.
Second Liquid Ejecting Head 31: a liquid ejecting head manufactured using a used head chip 300 in part, which has been removed from a first liquid ejecting head 31.
First Position: a position at which a head chip presumably having a relatively higher frequency of use is disposed as a result of comparison between frequencies of use of head chips.
Second Position: a position at which a head chip presumably having a relatively lower frequency of use than the head chip at the first position is disposed as a result of comparison between frequencies of use of head chips.
Characteristic Information of Used Head Chip: information related to the liquid ejection performance and various degrees of deterioration of a used head chip 300 when the used head chip 300 is collected. The information is expressed by the usage history of the used head chip 300 or the result of measurement of the used head chip 300 itself.
Initial Characteristic Value: information related to the ejection performance immediately after a head chip 310 or a used head chip 300 is manufactured. The information is expressed by data correlated with the ejection performance or data that identifies the classification to which the ejection performance belongs.
First Ranking and Classification: ranking and classification of a used head chip 300 based on the characteristic information.
Second Ranking and Classification: ranking and classification of a used head chip 300 based on the initial characteristic value.

A description will be given with reference to FIG. which illustrates an example of a cycle of manufacturing of a head chip 310 and recycle of a used head chip 300. After a head chip 310 or a liquid ejecting apparatus 10 including the head chip 310 is manufactured in a manufacturing process MFG, the product is provided to a market MRT, and due to a failure or a lapse of lifetime, or discontinued use by a user, the product is collected, and recycled in a recycle process RCL. In the recycle process RCL, the used head chip 300 is removed, ranked and classified, and a second liquid ejecting head 31x is further manufactured.

In the manufacturing process MFG, head chips 310 are first manufactured, and these are assembled as the liquid ejecting heads 31a, 31b which are further assembled as a head unit 3, which is finally embedded in a liquid ejecting apparatus 10. In this process, the initial characteristic value of the head chip 310 and information indicating the liquid ejecting head 31 in which the head chip is embedded are associated with each other, and saved in a database DB1 prepared in the cloud. The steps of manufacturing from the head chip 310 to the liquid ejecting apparatus 10 may be performed by the same manufacturer; however, at least part of the steps may be performed by an entity different from the manufacturer of the head chip 310. Even in the same liquid ejecting heads 31, the voltage waveform of the drive signal COM for driving the piezoelectric element 60, and the reference voltage Vm may vary with users.

The product such as the liquid ejecting apparatus is provided to the market MRT in the form of sales or lease, and due to a failure or expiration of a service period, the product is withdrawn from the market, and collected for the recycle process RCL. The collected liquid ejecting head 31a in which the used head chip 300 is embedded is exemplified as the first liquid ejecting head 31a in FIG. 8. The used head chip 300 removed from the first liquid ejecting head 31a is ranked and classified, and ranking and classification information is saved in a database DB2. Regarding the ranking and classification, first ranking and classification C1 based on the usage history of the used head chip 300, and second ranking and classification C2 based on the initial characteristic value of the used head chip 300 are performed, and the used head chip 300 is classified into ranks R11 to R14, R21 to R24 which are each a combination of these ranking and classification.

The ranked and classified used head chip 300 is embedded in a second liquid ejecting head 31x as at least part thereof. As the head chip 310 in the manufacturing process MFG, thus manufactured second liquid ejecting head 31x is embedded in a head unit, eventually in a liquid ejecting apparatus, and supplied to the market MRT, or alternatively, the second liquid ejecting head 31x is supplied to the market MRT as a single item.

The method of manufacturing a liquid ejecting head in the present embodiment is used in the recycle process RCL described above, thus is not directly related to the manufacturing of a liquid ejecting head in the manufacturing process MFG; however, in consideration of the measurement of the initial characteristic value of a liquid ejecting head in the manufacturing process MFG, manufacturing of a liquid ejecting head in the manufacturing process MFG will be generally described. In the manufacturing process MFG, a head chip 310 is first manufactured. A plurality of piezoelectric elements 60 are embedded in one head chip 310. The head chip 310 manufactured in the manufacturing process MFG is measured for initial characteristic value, and ranked and classified based on the measured initial characteristic value. In the present embodiment, the initial characteristic value is the natural frequency cycle Tc of the liquid in the pressure generation chamber 631 of the manufactured head chip 310. Instead of the natural frequency cycle Tc, the initial characteristic value may be the volume, the weight, or the ejection speed of the ink droplets which are ejected when the manufactured head chip is driven by the reference drive signal COM.

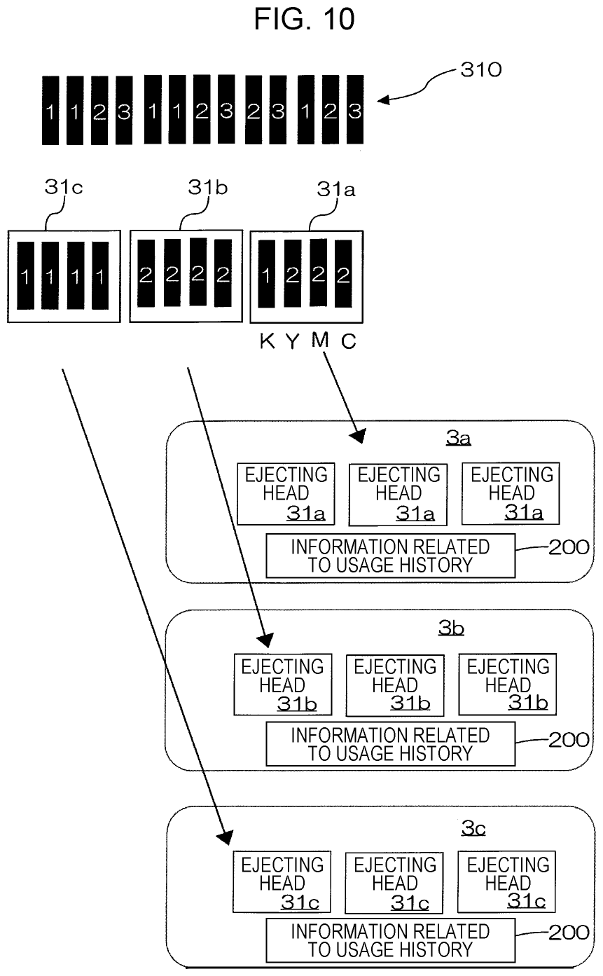

FIG. 9 schematically illustrates the initial characteristic value of the head chip 310, and the subsequent temporal change in the ejection performance of the head chip 310. In FIG. 9, the vertical axis indicates the ejection performance of the head chip 310, and the horizontal axis indicates the subsequent number of times of ejection or the operation time of the head chip. The ejection performance of the head chip 310, in other words, the ejection performance of the piezoelectric element 60 is e.g., the natural frequency cycle Tc of the liquid in the pressure generation chamber 631, the ejection speed or the ink weight of the ink droplets ejected when the manufactured head chip 310 is driven by the reference drive signal COM, or the displacement amount of the vibration plate 621. The ejection performance of the head chip 310 is correlated with the degree of deterioration of the piezoelectric element 60. The piezoelectric element 60 expands and contracts each time the drive signal COM is applied thereto, and the ejection performance varies according to the cumulative value (hereinafter referred to as the cumulative number of times of ejection) of the number of times of ejection. Thus, change in the characteristics due to use is illustrated in terms of the cumulative number of times of ejection, but even when the drive signal COM is not applied, if the reference voltage Vm is applied to the piezoelectric element 60, the ejection performance varies regardless of the presence or absence of ejection of liquid. Therefore, the time during which the drive signal COM and the reference voltage Vm are applied, in short, the operation time may be treated in the same manner as the cumulative number of times of ejection.

FIG. 9 illustrates a measured long-term characteristic change with a constant number of times of ejection per unit time. Also, in the present example, the reference voltage Vm is applied to the piezoelectric element regardless of the presence or absence of ejection of liquid, thus the cumulative number of times of ejection and the operation time can be treated as substantially the same parameters as the usage history of head chip. In FIG. 9, time t0 indicates the point in time when the head chip 310 is manufactured, and time ta indicates the timing of completion of the period of burn-in which is performed when the head chip 310 is manufactured. The ejection performance of the head chip 310 significantly changes in a certain time period after first use, so a burn-in process is performed in which a load is applied to the head chip 310 for a predetermined time prior to actual use. The period (time t0 to ta) of burn-in may vary with the size of the initial characteristic value. As illustrated, the ejection performance for the drive signal COM significantly reduces in the period of burn-in at the time of manufacturing, and the change in the ejection performance due to subsequent use decreases. In descending order of ejection performance Ci1, Ci2, and Ci3 at the time of completion of burn-in, typical characteristics of the head chip 310 are shown as characteristics CR1, CR2, and CR3. Generally, the characteristics of head chip 310 are distributed widely, but for the sake of better understanding, three typical examples are shown for which the ejection performance is high, medium, and low.

As the three typical examples, a solid line Cc1, a dash-dotted line Cc2 indicating an example of characteristics higher in ejection performance than the solid line Cc1, and a two-dot chain line Cc3 indicating an example of characteristics lower in ejection performance than the solid line Cc1 are illustrated. These differences will be described using an example of the characteristics CR1 for which the ejection performance corresponding to the initial characteristic value is the highest. Of the characteristics CR1, the solid line Cc1 with the start point at time ta of the completion of burn-in shows the change in the ejection performance when the ambient temperature Ta during use of the head chip 310 is 25° C. which is assumed as room temperature, and the reference voltage Vm of the drive signal COM is an average voltage Vav. The dash-dotted line Cc2 shows the change in the ejection performance when the ambient temperature Ta during use of the head chip 310 is 15° C. which is lower than room temperature, and the reference voltage Vm of the drive signal COM is a voltage Vs which is lower than the average voltage Vav. In addition, the two-dot chain line Cc3 shows the change in the ejection performance when the ambient temperature Ta during use of the head chip 310 is 45° C. which is higher than room temperature, and the reference voltage Vm of the drive signal COM is a voltage Vl which is higher than the average voltage Vav. Such change in the characteristics also applies to the characteristics CR2.

As described below, the ejection performance of the head chip 310 deviates with the operation time, but as a whole, has a high correlation with the initial characteristic value that is the ejection performance at the time of manufacturing, thus the head chip 310 is ranked and classified based on the initial characteristic value at time t0 of manufacturing. This corresponds to the second ranking and classification C2, and hereinafter this is called ranks 1, 2, and 3 as necessary. The ranks 1, 2, and 3 indicate that the ejection performance at time t0 illustrated in FIG. is included in range “1”, in range “2”, and in range “3”, respectively. As described below, the used head chip 300 once used as a product in the market is also ranked and classified based on the usage history such as the number of times of ejection; however, there is no usage history other than burn-in at the point of time of the manufacturing process MFG, thus ranking and classification based on the usage history is not performed. The ranks A to D and a to d based on the usage history illustrated in FIG. 9 will be described in detail later.

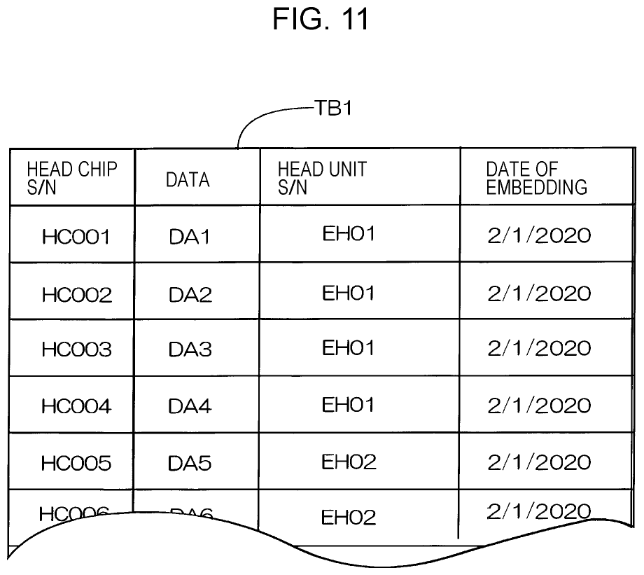

The manner of ranking and classification of the head chips 310 at the time of manufacturing is illustrated in FIG. 10. The uppermost part of FIG. 10 shows the ranks of manufactured head chips 310 which are classified based on the initial characteristic value at the time of manufacturing. The head chips 310 are labeled with numbers “1”, “2” or “3” which indicate that the initial characteristic values of the head chips 310 correspond to head chips represented by the characteristics CR1, CR2, and CR3 illustrated in FIG. 9. In the present embodiment, the liquid ejecting heads 31a to 31c are constructed, for example, by combining the head chips 310 in rank 1 and rank without using the head chips 310 in rank 3 which indicates low ejection performance based on the initial characteristic value. However, a liquid ejecting head 31 may be constructed by combining the head chips 310 in rank 3. In this case, as illustrated, the head chips 310 with similar initial characteristic values may be combined. The liquid ejecting head 31c indicates an example constructed only by the head chips 310 classified into the rank 1. The liquid ejecting head 31b indicates an example constructed only by the head chips 310 classified into the rank 2. The liquid ejecting head 31a is an example in which the head chips 310 in the rank 1 are used at the first position where the head chips 310 for black ink K are disposed, which normally have a largest number of times of ejection when used for the same time period, in other words have a high frequency of ejection, and the head chips 310 in the rank 2 are used at the second position where the head chips 310 for CMY are disposed, which are assumed to have a lower frequency of ejection than the head chips 310 at the first position.

Besides, thus constructed liquid ejecting heads 31a, 31b, 31c are combined to construct the head units 3a to 3c. The head units 3a to 3c are each used in a liquid ejecting apparatus. FIG. 10 illustrates the head unit 3a which is manufactured by combining only liquid ejecting heads 31a, and the head units 3b, and 3c which are manufactured by combining only liquid ejecting heads 31b, and liquid ejecting heads 31c, respectively. FIG. 10 also illustrates the memory 200 that stores information related to usage history, and as already described, the memory 200 is the memory provided in each head chip 310. The memory stores usage history, and ranking and classification using the memory content and the usage history will be described in detail later. The memory 200 may store initial characteristic values along with the usage history, and as described below, the initial characteristic values are recorded in the database DB1 in the cloud in the present embodiment.

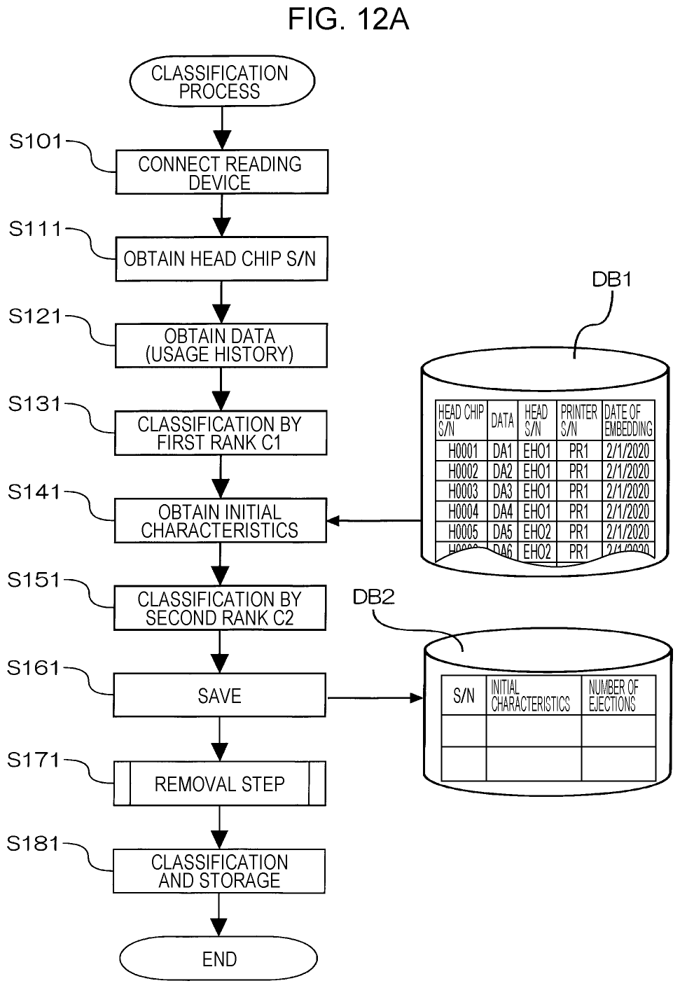

An example of recording of initial characteristic values is illustrated in FIG. 11. In the record shown as table TB1 in FIG. 11, the serial number (shown as S/N in FIG. 11) of the head chip 310 is associated with “data”, the serial number of the liquid ejecting head 31, and the date of embedding on which the head chip 310 is embedded in the liquid ejecting apparatus 10. The “data” includes the ranks 1, and 2 based on the initial characteristic value. These records are saved as the database DB1 on a site in the cloud, and are referred to, as described below, when a new liquid ejecting head 31 corresponding to a second liquid ejecting head is constructed using used head chips removed from a liquid ejecting head 31 corresponding to a first liquid ejecting head.

Thus constructed liquid ejecting heads 31a, 31b, and 31c form the head units 3a, 3b, and 3c, and the head units are embedded in the apparatus body, thus liquid ejecting apparatuses 10a, 10b, and 10c as the product are manufactured. The manufactured liquid ejecting apparatuses 10a, 10b, and 10c are shipped to the market MRT, and will be used at hand of users (see FIG. 8).

### (A5) Method of Manufacturing Liquid Ejecting Head—Rank And Classification Step

Next, the method of manufacturing a liquid ejecting head in the present embodiment will be described. The manufacturing method is performed in the recycle process RCL illustrated in FIG. 8, and roughly includes a ranking and classification step, a selection step, and an assembly step. The ranking and classification step in the present embodiment includes a first ranking and classification step in which the plurality of used head chips 300 included in the first liquid ejecting head 31a are classified into a plurality of ranks based on the characteristic information of each of the plurality of used head chips 300 included in the first liquid ejecting head 31a. The selection step selects used head chips 300 to be embedded in the second liquid ejecting head 31x among the plurality of used head chips 300 so that the second liquid ejecting head 31x includes a plurality of used head chips 300 classified into different ranks in the first ranking and classification step. In addition, the used head chips 300 selected in the selection step are embedded in the second liquid ejecting head 31x. These steps will be described sequentially below.

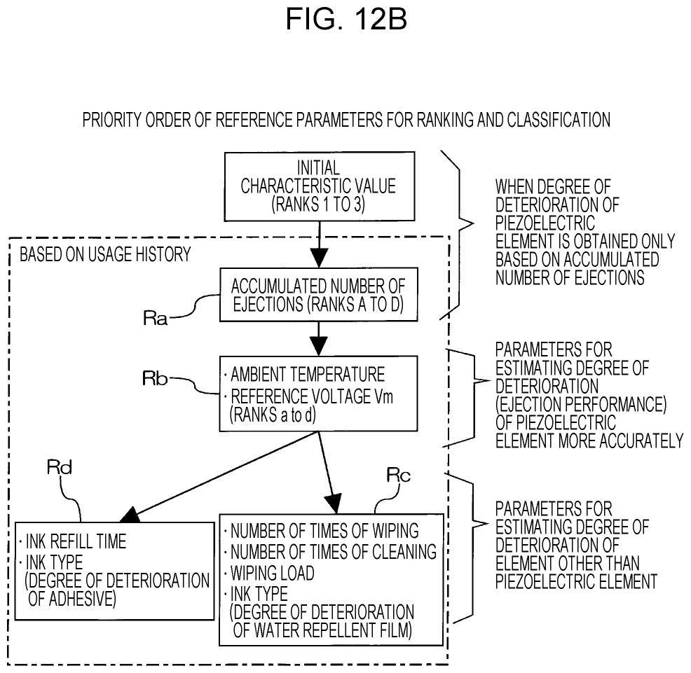

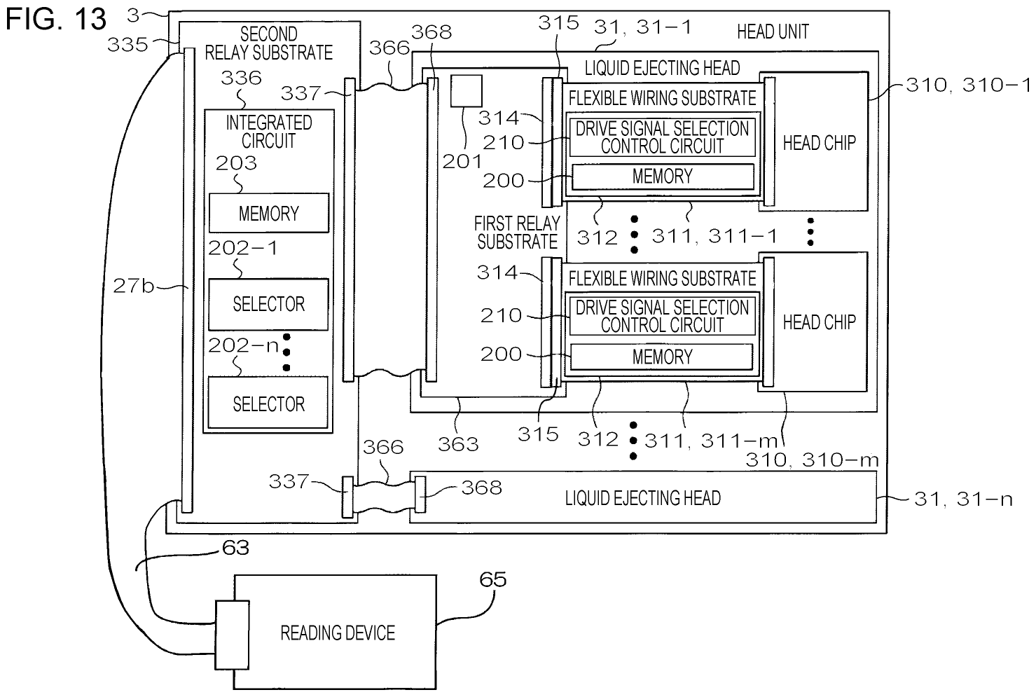

FIG. 12A is a flowchart illustrating an example of ranking and classification step. Prior to implementation of the ranking and classification step, the head units 3 included in the liquid ejecting apparatus 10a and the like which have been collected from the market MRT are taken out. Thus, in the ranking and classification step, a reading device 65 is connected so that a memory 200 can be accessed, the memory 200 being provided in the used head chips 300 included in the liquid ejecting head 31a handled as the first liquid ejecting head (step S101). As illustrated in FIG. 13, connection to the reading device 65 is achieved by connecting a connection cable 63 of the reading device 65, for example, to the connector 27b of the second relay substrate 335 of the head unit 3. At this point, the originally connected cable 17 may be utilized instead of the connection cable 63.

In the present embodiment, since the reading device is connected to the connector 27b of the second relay substrate 335, the usage history of each used head chip 300 included in all the first liquid ejecting heads 31a connected to the second relay substrate 335 can be successively read from each memory 200 provided in each used head chip 300. When the reading device 65 is connected to the connector 315 of a used head chip 300, the characteristic information of the used head chip 300 can be successively read from the memory 200 provided in the flexible wiring substrate 311. Note that signals and electric power necessary for reading data such as usage history from the memory 200 are output from the reading device 65 to the second relay substrate 335, the first relay substrate 363, and the flexible wiring substrate 311 through the connection cable 63.

Note that the connection cable 63 of the reading device 65 may be connected to the connector 368 of the first relay substrate 363, and in this case, the usage history of all the head chips 310-1 to 310-m included in one first liquid ejecting head 31a and the like can be successively read from each memory 200. The usage history for each used head chip 300 may be read by connecting the connection cable of the reading device 65 to the connector 315 provided in the flexible wiring substrate 311 of the used head chip 300. One end of the connection cable 63 may be provided with a connector connectable to one of the connector 27b, the connector 368, and the connector 315.

When the reading device 65 is connected, the memory is accessed to obtain the serial number (S/N) of each used head chip 300 embedded in the mounted first liquid ejecting head 31a and the like (step S111). In the same manner, a process of reading, from the memory 200, data of each used head chip 300 embedded is performed, in this case, the data is the accumulated number of times of ejection (hereinafter also referred to as the cumulative number of times of ejection) which is usage history (step S121). The first ranking and classification C1 process is performed by classifying each used head chip 300 using the data read (step S131).

The characteristic information such as the cumulative number of times of ejection can be obtained from the data stored in the memory 200 mounted on each used head chip 300 of the first liquid ejecting head 31a and the like. At least the number of times of ejection of each used head chip 300 is included in the memory 200 as information correlated with ejection performance. The control circuit of the liquid ejecting apparatus 10a and the like accumulates the number of times of ejection upon instructing each head chip 310 to eject ink droplets, and the result is stored at a predetermined timing in the memory 200 on the flexible wiring substrate 311 associated with each head chip. Thus, when the reading device 65 is connected, the characteristic information of each used head chip 300 can be obtained from the memory 200 mounted on the head unit 3a and the like. As illustrated in FIG. 9, when the number of times of use of the head chip increases, the ejection performance generally decreases. Therefore, the number of times of ejection can represent the characteristic information of the used head chip 300, and can serve as the later-described guide for recycle. Thus, the first ranking and classification C1 can be performed by reading the number of times of ejection of each used head chip 300 from the memory 200, and determining one of predetermined classifications A to D based on usage history, to which the number of times of ejection belongs.

As illustrated in FIG. 9, when the number of times of ejection of a head chip reaches a predetermined value, the ejection capability of the head chip is significantly affected by the initial characteristic value of the head chip. Thus, the initial characteristic values of the head chips included in one liquid ejecting head 31 are often made matched as shown in the head units 3b, 3c of FIG. 10. This is because the reference voltage Vm of the drive signal COM to be applied to the piezoelectric element 60 of the plurality of head chips included in one liquid ejecting head can be made common. Thus, also for the used head chips 300, ranking and classification may be performed based on the classification to which the initial characteristic value belongs. Thus, subsequent to the first ranking and classification (step S131), the second ranking and classification step (step S141, S151) based on initial characteristic value is performed.

In step S141, the database DB1 is accessed based on the serial number (S/N) of the head chip obtained in step S111, and the initial characteristic value of each used head chip 300 is obtained. Furthermore, in step S151, the second ranking and classification C2 is performed using the obtained initial characteristic value. The second ranking and classification C2 is performed by determining whether the initial characteristic value of the used head chip 300 belongs to classification 1 or 2 illustrated in FIG. 9.

Subsequently, the information on each used head chip 300 ranked and classified by the first ranking and classification C1 and the second ranking and classification C2 is saved in the database DB2 in association with the serial number (step S161). The data of each used head chip ranked and classified is saved in the database DB2 with the serial number of the head chip associated with the cumulative number of times of use and the initial characteristic value. The database DB2 may be saved in the cloud, or may be saved locally. The database DB2 may be regarded as data representing the inventory of used head chips 300 classified into ranks.

Subsequently, a removal step for removing a used head chip 300 embedded in the first liquid ejecting head 31a and the like is performed (step S171). The removed used head chip 300 is classified into the above-mentioned ranks, and stored (step S181). Thus, the process of ranking and classification is completed. In the first ranking and classification C1, the used head chip 300 is classified into classifications A to D, and the classification D is a “non-recyclable rank” exceeding a usage limit, and a used head chip 300 in the classification D may be excluded from the target of the selection step.

The actual details of the first ranking and classification C1, and the second ranking and classification C2 will be described below. In step S121, S131, as the usage history, the cumulative number of times of ejection is used, and the first ranking and classification C1 is performed based on the one of the classifications A to D shown in FIG. 9, to which the cumulative number of times of ejection belongs. In step S141, S151, the second ranking and classification C2 is performed by determining whether the ejection performance immediately after the manufacturing of each used head chip 300 belongs to classification 1 or 2 of initial characteristic value illustrated in FIG. 9. In FIG. 9, classification 3 is also shown as a classification of initial characteristic value; however, as already described, the head chip 310 with the initial characteristic value in the classification 3 is non-recyclable and not used, thus in the second ranking and classification C2, the used head chip 300 is ranked and classified into classification 1 or classification 2.

As shown in the lower part of FIG. 8, each used head chip 300 is ranked and classified by the first ranking and classification C1 and the second ranking and classification C2 based on the cumulative number of times of ejection and the initial characteristic value. In this example, the first ranking and classification C1 based on the cumulative number of times of ejection is performed resulting in four classifications, and the second ranking and classification C2 based on the initial characteristic value is performed resulting in two classifications. Thus, there are eight resulting ranks in total: R11 to R14 and R21 to R24.

In the above ranking and classification step, the first ranking and classification C1 based on the usage history, and the second ranking and classification C2 based on the initial characteristic value are independently performed; however, the first ranking and classification C1 and the second ranking and classification C2 may be performed in both combined manner. A technique of ranking and classification in both combined manner will be described below.

As illustrated in FIG. 9, the ejection performance of head chip after predetermined burn-in changes with increase of the number of times of ejection, and the degree of the change is affected by the difference in the ambient temperature and the reference voltage Vm of the drive signal COM. For used head chip 300, the initial characteristic value and the change in the ejection performance due to subsequent use have been studied for each of parameters, such as the ambient temperature and the reference voltage Vm of the drive signal COM, which have an effect on the ejection performance, thus when the initial characteristic value and the parameter are known, it is possible to estimate how the ejection performance changes with increase of the number of times of ejection with high probability. Thus, as shown in an example of FIG. 9, when the classifications of the ejection performance, such as ranges a, b, c, d are assumed based on the initial characteristic value and various parameters relative to the ejection performance achieved by burn-in, the rank of the used head chip 300 for the number of times of ejection at a certain point in time can be determined. This corresponds to ranking and classification of the used head chip 300 based on the usage history for each initial characteristic value, in other words, based on a combination of the initial characteristic value and the usage history.

For example, when a head chip 310 with ejection performance Ci1 as the initial characteristic value is used with voltage Vs as the reference voltage Vm at an ambient temperature of 15° C., the rank based on the usage history of the used head chip 300 at ejection time te is the rank b according to the dash-dotted line Cc2 illustrated. Similarly, when a used head chip 300 with ejection performance Ci1 as the initial characteristic value is used with voltage VAV as the reference voltage Vm at an ambient temperature of 25° C., the rank based on the usage history of the head chip at ejection time te is the rank c according to the solid line Cc1 illustrated. When used with voltage Vl as the reference voltage Vm at an ambient temperature of 45° C., the rank based on the usage history of the used head chip 300 at ejection time te is the rank d according to the two-dot chain line Cc3. Here, the rank d is a non-recyclable rank exceeding a usage limit, thus a used head chip 300 in the rank d may be excluded from the target of the selection step.

As the usage history to be combined with the initial characteristic value, typical parameters are listed below. These parameters are correlated with the degree of deterioration of the piezoelectric element 60.
Cumulation Number of Times of Ejection (Operation Time) The details have been described above, so a description is omitted here. Note that the first ranking and classification C1 based on the degree of deterioration of the piezoelectric element 60 may be performed only based on the cumulative number of times of ejection (operation time) without using a usage history such as the operating ambient temperature and the reference voltage Vm. In this case, in the first ranking and classification C1, a used head chip is classified into the ranks A to D. Note that the first ranking and classification C1 in the present embodiment is performed only based on the cumulative number of times of ejection (operation time), and each used head chip 300 is classified into the ranks A to D.
Operating Ambient Temperature: the above-mentioned temperature of a used head chip 300 when used. The ambient temperature of a used head chip 300 when used is not necessarily always the same, so an average temperature may be determined to be the ambient temperature, or an ambient temperature may be determined for every operation time, and the value obtained by accumulation may be treated as a parameter of the ambient temperature. Specifically, for the first ranking and classification C1 based on the degree of deterioration of the piezoelectric element 60, the used head chips 300 may be classified into ranks a to d by using the reference voltage Vm in combination with the cumulative number of times of ejection (operation time). Note that the used head chip 300 may be classified into the ranks a to d based on a combination of the cumulative number of times of ejection (operation time) and the operating ambient temperature only without using the reference voltage Vm.
Reference Voltage Vm: the above-mentioned potential difference between the intermediate potential Vc and the reference potential Vbs of the drive signal COM applied to the used head chip 300. A voltage value itself may be used, or voltage value is divided into multiple segments, and the segment to which the reference voltage Vm belongs may be used. Specifically, in the first ranking and classification C1 based on the degree of deterioration of the piezoelectric element 60, the used head chips 300 may be classified into the ranks a to d by using the operating ambient temperature in combination with the cumulative number of times of ejection (operation time). Note that the used head chips may be classified into the ranks a to d based on a combination of the cumulative number of times of ejection (operation time) and the reference voltage Vm only without using the operating ambient temperature. The ranks a to d are provided for each of the ranks 1, 2 of the initial characteristic value.

In addition to the parameter for the degree of deterioration of the piezoelectric element 60, as the usage history as the characteristic information to be used in the first ranking and classification, the following may be listed as typical parameters. The following is the parameters for estimating the degree of deterioration of elements other than the piezoelectric element 60.
Ink Filling Time: the degree of deterioration of the adhesive used for constructing a used head chip 300 has an effect on determination as to whether the used head chip 300 can be used continuously. The degree of deterioration of the adhesive is affected by the time period during which ink is filled in the common liquid chamber or the pressure generation chamber 631 of the used head chip 300. Specifically, when the first ranking and classification is performed based on the degree of deterioration of the adhesive, for a longer ink filling time, the used head chip is classified into a rank with a higher degree of deterioration. The first ranking and classification may be performed based on further accurately estimated degree of deterioration of the adhesive by combining the type of ink to be filled with the ink filling time. Thus, not only the ink filling time, but also a parameter such as an ink type may be included in the usage history as the characteristic information to be used in the first ranking and classification.
Number of Times of Wiping: similarly, the degree of deterioration of the water repellent film 658 provided in the used head chip 300 has an effect on determination as to whether the used head chip 300 can be used continuously. The degree of deterioration of the water repellent film 658 is affected by the number of times of wiping. Specifically, when the first ranking and classification is performed based on the degree of deterioration of the water repellent film 658, for a larger number of times of wiping, the used head chip 300 is classified into a rank with a higher degree of deterioration. The first ranking and classification may be performed based on further accurately estimated degree of deterioration of the water repellent film 658 by combining the pressing load applied to the water repellent film 658 by the wiping member WP used for wiping and the type of ink adhering to the water repellent film 658 with the number of times of wiping. Thus, not only the number of times of wiping, but also a parameter such as a wiping load and an ink type may be included in the usage history as the characteristic information to be used in the first ranking and classification.
Number of Times of Cleaning Process: the degree of deterioration of the nozzles 651 of a used head chip 300 can be recognized as e.g., the frequency of clogging and the number of nozzles clogged. If a nozzle is clogged, the operation of cleaning process is performed, thus when the first ranking and classification is performed based on the degree of deterioration of the nozzles 651, for a larger number of times of cleaning process, the used head chip 300 is classified into a rank with a higher degree of deterioration.

FIG. 12B illustrates an example of a priority order in ranking and classification based on a combination of various usage history treated as characteristic information and the initial characteristic value. In the example illustrated, the following ranking and classification processes Ra to Rc are performed as the second ranking and classification process based on the initial characteristic value (the ranks 1 to 3 in FIG. 9) and the first ranking and classification based on usage history.
Process Ra: ranking and classification process (the ranks A to D in FIG. 9) based on the cumulative number of times of ejection.
Process Rb: ranking and classification process (the ranks a to d in FIG. 9) based on the ambient temperature and the reference voltage Vm.
Process Rc: ranking and classification process based on the degree of deterioration of the water repellent film. Process Rd: ranking and classification process based on the degree of deterioration of the adhesive.

Although not illustrated, ranking and classification other than these, for example, a ranking and classification process based on the degree of deterioration of nozzles may be combined. In the first ranking and classification based on these pieces of usage history, a used head chip 300 classified as the “non-recyclable rank” which does not ensure continuous use even in one of the processes Ra to Rd may be excluded from the target of recycle. The parameters of these pieces of usage history may be all considered, or may be considered in part.

The parameters for these pieces of usage history, specifically, the usage history such as the cumulative number of times of ejection that increases with use, the number of times of execution of wiping, the ambient temperature at the time of use, and the reference voltage Vm is counted by the control circuit 71 of the drive circuit substrate 7, and written to the memory 200 provided in each head chip 310 as needed via the second relay substrate 335 and the first relay substrate 363. As described above, the cumulative number of times of ejection may be replaced by the operation time of the head chip 310 or the liquid ejecting head 31a and the like.

### (A6) Method of Manufacturing Liquid Ejecting Head—Selection and Assembly Step

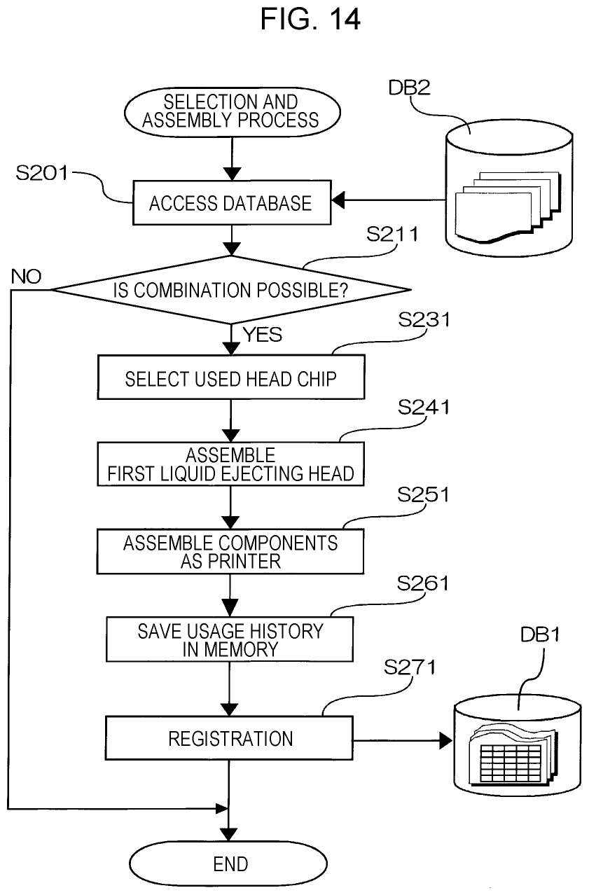

Next, the process of constructing a new liquid ejecting head 31 using used head chips 300 will be described. FIG. 14 is a flowchart illustrating a selection and assembly step. Herein, the second liquid ejecting heads 31x, 31y which are liquid ejecting heads similar to the first liquid ejecting head 31a are manufactured using the used head chips 300 embedded in the first liquid ejecting heads 31a, 31b which are liquid ejecting heads used in the liquid ejecting apparatus 10a and the like.

When assembling of the second liquid ejecting heads 31x, 31y is started, the database DB2 is first accessed (step S201). The database DB2 is the one into which data is written and saved in step S161 of FIG. 12. The database DB2 is information stored as a database, the information being related to the used head chips 300 which have been collected from the market MRT, classified and stored based on the ranking and classification, and managed. Thus, it is determined, based on the data read from the database DB2, whether a combination of a necessary number of used head chips 300 to assemble the second liquid ejecting heads 31x, 31y is possible (step S211). Since the database DB2 represents the inventory of used head chips 300 classified into ranks, it can be easily known whether there are a necessary number of used head chips 300 having desired characteristics by reading the database DB2. When it is determined that a new second liquid ejecting head 31x and the like cannot be assembled by a combination (“NO” in step S211), nothing is performed, and the present assembly step is finished.

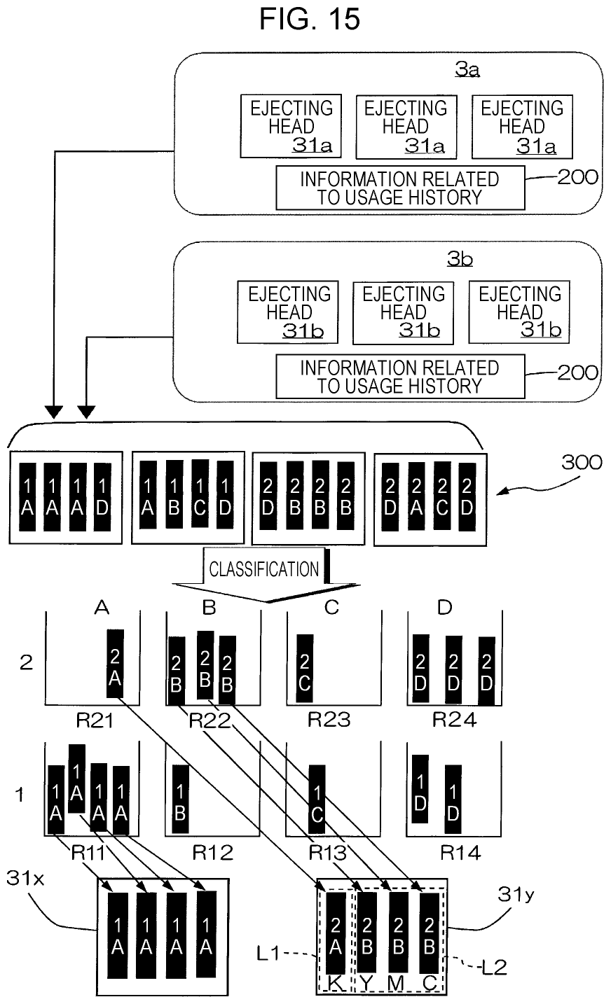

When it is determined that a combination of used head chips 300 to assemble the second liquid ejecting heads 31x and the like is possible (“YES” in step S211), the used head chips 300 are then selected based on the data read from the database DB2 (step S231). An example of selection is illustrated in FIG. 15. For the sake of better understanding, FIG. 15 first illustrates disassembly of the used head chips 300 mounted on the head units 3a, 3b collected from the market. The liquid ejecting heads 31a, 31b in FIG. 15 correspond to the “first liquid ejecting head”. The liquid ejecting heads 31a, 31b taken out from the head units 3a, 3b include a plurality of used head chips 300, and the ejection performance varies with each used head chip 300. In FIG. 15, in the notation “1A” and the like, “1”, “2” correspond to the ranks “1”, “2” of initial characteristic value described with reference to FIG. 8, and “A”, “B”, “C”, and “D” correspond to the classifications “A”, “B”, “C”, and “D” of the number of times of ejection. The used head chips 300 obtained by disassembling the first liquid ejecting heads 31a, 31b are ranked and classified based on the initial characteristic value and the cumulative number of times of ejection, specifically are classified into the ranks R11 to R14, R21 to R24, and stored in a warehouse or the like. These classified used head chips 300 correspond to the information recorded in the database DB2. In FIGS. 8 and 15, the used head chips 300 classified as the rank D, that is, the “non-recyclable rank” in the first ranking and classification C1 are classified as the rank R14 or R24, then stored. However, since the used head chips 300 classified as the rank R14 or R24 are not recycled, the used head chips 300 classified as the rank D after the first ranking and classification C1 may be discarded, so the used head chips 300 classified as the rank R14 or R24 do not need to be stored.

Next, from these classified used head chips 300, the used head chips 300 with the same rank of the initial characteristic value are combined to construct the second liquid ejecting heads 31x, 31y. The second liquid ejecting head 31x illustrated is constructed by selecting used head chips 300 with the initial characteristic value in the rank “1”, and the cumulative number of times of ejection in the rank “A”, in short, from the inventory in the rank R11. The second liquid ejecting head 31y illustrated is constructed by selecting one from the used head chips 300 with the initial characteristic value in the rank “2”, and the cumulative number of times of ejection in the rank “A”, in short, from the inventory in the rank R21, the one corresponding to ejection of black (K) ink presumably having a relatively high frequency of use, and other three are constructed by selecting from used head chips 300 with the initial characteristic value in the rank “2”, and the cumulative number of times of ejection in the rank “B”, in short, from the inventory in the rank R22. The latter three head chips are for cyan (C), magenta (M), yellow (Y) which have a lower frequency of ejection than black ink. The position at which the head chip for K ink is mounted is known in advance, and the position corresponds to a first position L1. The position at which the head chip for CMY ink is mounted is also known in advance, and the position corresponds to a second position L2. Note that the first position L1 and the second position L2 each correspond to one of a plurality of positions at which a plurality of head chips are disposed in the housing space S. In this manner, a head chip in a rank with a less cumulative number of times of ejection can be mounted at the position of a head chip with a high frequency of ejection. The used head chip 300 mounted at the first position L1 corresponds to a “first used head chip”, and the used head chip 300 mounted at the second position L2 corresponds to a “second used head chip”. As described above, even when used head chips 300 have different cumulative numbers of times of ejection, with the same operation time, reference voltage Vm, and ambient temperature, the used head chips 300 exhibit a similar degree of deterioration of the piezoelectric element 60. However, in a used head chip 300 having a larger number of times of ejection, a stress caused by displacement of the vibration plate 621 at the time of ejection is more likely to be applied to the vibration plate 621 than in a used head chip 300 having a smaller number of times of ejection, thus the used head chip 300 having a larger number of times of ejection is likely to fail, and the estimated lifespan of the used head chip 300 is shorter for a larger number of times of ejection. Thus, the usable time period of the whole second liquid ejecting head 31y can be extended by adopting the above-described mounting method. Generally, when the inventory of head chips in the rank R21 is sufficient, a used head chip 300 in “2A” may be selected for the latter.

In the above configuration, a used head chip 300 with a smaller number of times of ejection is disposed at the first position L1, and a used head chip 300 with a greater number of times of ejection is disposed at the second position L2, but this is not always the case. For example, the rank of the degree of deterioration of the elements other than the piezoelectric element 60 of the used head chip 300 as the “first used head chip” mounted at the first position L1 may be lower than the rank of the degree of deterioration of the elements other than the piezoelectric element 60 of the used head chip 300 as the “second used head chip” mounted at the second position L2. For example, for a head chip having a high frequency of ejection, wiping and cleaning process are performed more often than for a head chip having a low frequency of ejection. Specifically, in a head chip having a high frequency of ejection, the water repellent film 658 and nozzle 651 are more likely to deteriorate than in a head chip having a low frequency of ejection, thus a used head chip 300 in a rank that is lower in degree of deterioration of the water repellent film or in a rank that is lower in degree of deterioration of the nozzles 651 than the used head chip 300 mounted at the second position L2 may be mounted at the first position L1.

Thus obtained second liquid ejecting heads 31x, 31y are constructed using the used head chips 300 removed from disassembled head units 3a and the like which are collected from market MRT, and the assembled used head chips 300 have sufficient performance that ensures use in the market MRT. Therefore, the second liquid ejecting heads 31x, 31y in which the used head chips 300 are embedded in step S231, S241 can be handled as liquid ejecting heads having sufficient ejection capability and lifespan.

The second liquid ejecting head 31x or 31y is embedded in the head unit 3, and the liquid ejecting apparatus 10 is assembled by incorporating the head unit 3 into the apparatus body 2 (step S251). Step S251 may be omitted, and the second liquid ejecting heads 31x, 31y may be supplied to the market MRT again as single items. In step S251, assembly of the liquid ejecting apparatus 10 may be omitted, and in this case, the head unit 3 including the second liquid ejecting head 31x or 31y is supplied to the market MRT again.

The reading device 65 may allow writing of data, and in this case, by connecting to the reading device 65, information on the usage history of the used head chip 300 embedded in the second liquid ejecting head 31, specifically, data such as the cumulative number of times of ejection is saved in at least one of the memory 201 of the second liquid ejecting head 31 and the memory 203 of the head unit 3 included in the second liquid ejecting head 31 (step S261). Specifically, when the usage history accumulated after supply of the second liquid ejecting head to the market again is stored in the memory 201 of the second liquid ejecting head 31, information on the usage history of the used head chip 300 may be saved in the memory of the second liquid ejecting head 31. When the usage history accumulated after second supply of the second liquid ejecting head 31 to the market is stored in the memory 203 of the head unit 3 included in the second liquid ejecting head 31, information on the usage history of the used head chip 300 may be saved in the memory 203 of the head unit 3. Since the used head chip 300 in the present embodiment stores the usage history in the memory 200, when the usage history accumulated after second supply of the second liquid ejecting head 31 to the market is stored in the memory 200 of the used head chip 300 embedded in the second liquid ejecting head 31, step S261 may be omitted.

Subsequently, information on the used head chips in the second liquid ejecting heads 31x, 31y is registered in the database DB1 as information on a new used head chip 300 (step S271). In the registration of the used head chip 300 (step S271), the serial number of the head chip 310 is already registered in the database DB1, thus the data may be overwritten, or may be recorded in existing data as supplement because the head chip has been supplied to the market once. After the above process, “END” is reached, and manufacturing of the liquid ejecting head is completed.

According to the method of manufacturing a liquid ejecting head in the first embodiment described above, the head chips 310 installed in the liquid ejecting head 31a and the like mounted on the liquid ejecting apparatus 10a and the like of printers once supplied to the market are collected as used head chips 300, the collected used head chips 300 are ranked and classified based on the characteristic information, and the second liquid ejecting head 31y and the like as new liquid ejecting heads can be manufactured. Thus, usable used head chips 300 do not need to be discarded uselessly, which can contribute to resource saving.

Because the second liquid ejecting head 31y includes a plurality of used head chips 300 classified in different ranks, used head chips 300 corresponding to the first used head chip and the second used head chip can be respectively disposed at the first position L1 and the second position L2 at which head chips having different frequencies of ejection are used. Therefore, it is possible to decrease the possibility of reduced lifespan of the second liquid ejecting head 31y due to a failure caused by a difference in the frequency of use in part of a plurality of used head chips 300 embedded in the second liquid ejecting head 31y.

In the present embodiment, a used head chip 300 is ranked and classified based on a combination of the initial characteristic value recorded at the time of manufacturing in association with the serial number of the head chip 310, and the usage history related to the degree of deterioration of the piezoelectric element 60 due to subsequent use in the market, thus the characteristics of the used head chip 300 in the newly manufactured second liquid ejecting head 31y can be made appropriate according to the application. Note that ranking and classification is not necessarily performed based on a combination the initial characteristic value and the usage history, and may be performed based on the usage history only. Alternatively, ranking and classification may be performed based on the usage history related to the degree of deterioration of the elements other than the piezoelectric element 60, or based on a combination of the initial characteristic value, the usage history related to the degree of deterioration of the piezoelectric element 60, and the usage history related to the degree of deterioration of the elements other than the piezoelectric element 60.

In this manner, according to the present embodiment, when a second liquid ejecting head 31y is constructed, the second liquid ejecting head 31y is to include used head chips 300 in different ranks of ejection performance from the used head chips 300 classified based on the characteristic information of the used head chip 300, that is, based on the initial characteristic value and the usage history. In contrast, as in the second liquid ejecting head 31x, it is possible to have uniform ejection performance of a plurality of used head chips 300 embedded in the second liquid ejecting head 31x. In this manner, it is possible to decrease the possibility of reduced lifespan of the second liquid ejecting head 31x due to a variation in the ejection performance of the used head chips 300 embedded in the second liquid ejecting head 31x.

In the present embodiment, the liquid ejecting apparatus 10 is a printer that ejects CMYK ink, thus even when the plurality of used head chips 300 embedded in the second liquid ejecting head 31y have different ranks based on the usage history, the image quality in color printing is easily guaranteed using the used head chips 300 with the initial characteristic value in the same rank.

### B. Second Embodiment

Next, a second embodiment of a method of manufacturing a liquid ejecting head will be described. In the second embodiment, as in the first embodiment, the head chip 310 is manufactured, the liquid ejecting head 31a and the like in which the head chip 310 is embedded is manufactured, the head unit 3a and the like is further assembled using the liquid ejecting head 31a, the liquid ejecting apparatus 10a and the like is manufactured using the head unit 3a, and the liquid ejecting apparatus 10a is supplied to the market. At this point, using the serial number of the head chip 310, data such as an initial characteristic value is linked to the serial number, and recorded on the database DB1. A used head chip 300 collected from the market is ranked, classified, and stored, then the data is recorded on the database DB2. In addition, also in the second embodiment, liquid ejecting heads collected from the market are regarded as first liquid ejecting heads 31a and the like, the head chips 310 embedded in these are recycled as the used head chips 300, and the second liquid ejecting heads 31x, 31y are assembled. So far, the process is the same as in the first embodiment.

The second embodiment differs from the first embodiment in that part the plurality of used head chips 300 included in the first liquid ejecting head 31a is not removed from the first liquid ejecting head 31a, but is used as it is in the second liquid ejecting head 31y. In the case of the second embodiment, part of the used head chips in the first liquid ejecting head 31a is used as it is, the rest of the used head chips 300 is replaced, and the second liquid ejecting head 31y is manufactured.

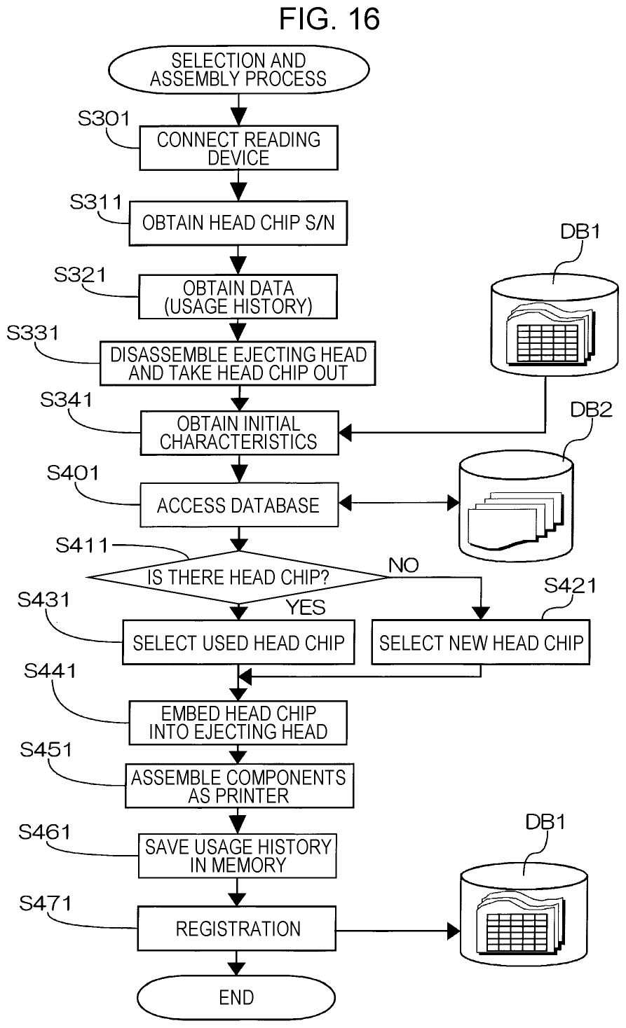

FIG. 16 is a flowchart illustrating a manufacturing step for a liquid ejecting head in this case. In this step, first, as exemplified in FIG. 13, the reading device 65 is connected to the head unit 3a embedded in the first liquid ejecting head 31a (step S301). The reading device 65 may be connected to the first liquid ejecting head 31a. Next, the serial number (S/N) of each used head chip 300 is obtained from the memory 200 corresponding to the used head chip 300 used in the first liquid ejecting head 31a (step S311). Subsequently, a process of reading data of each used head chip 300 embedded is performed, in this case, the data is the cumulative number of times of ejection which is an example of usage history of the used head chip 300 (step S321).

Subsequently, a used head chip 300z which is unusable as it is for the second liquid ejecting head 31y is removed from the used head chips 300 included in the first liquid ejecting head 31a (step S331). The used head chip 300z unusable as it is for the second liquid ejecting head 31y is as follows:
A used head chip 300z known to be faulty in advance.
A head chip 300z that cannot be recycled because the cumulative number of times of ejection, which is an example of usage history, is excessive, and classified into e.g., the classification “D” which is a non-recyclable rank.
A used head chip 300z that has a highest degree of deterioration among the used head chips 300 of the first liquid ejecting head 31a. The used head chip 300z corresponds to a “third used head chip”.

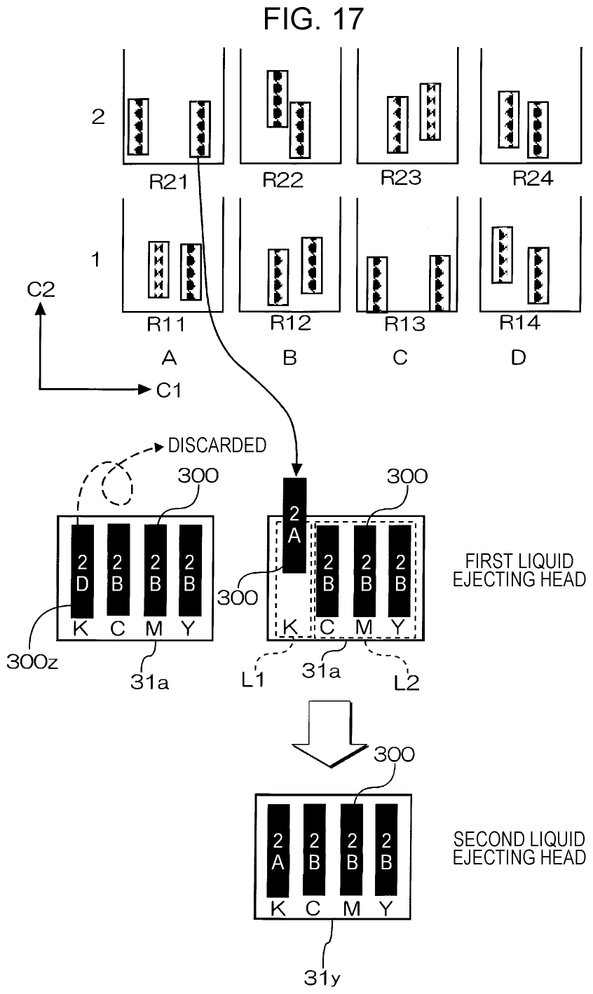

FIG. 17 illustrates the manner in which a used head chip 300z unusable as it is for the second liquid ejecting head 31y is removed from the first liquid ejecting head 31a. In FIG. 17, the first liquid ejecting head 31a is illustrated at the left end of the middle part. Among four used head chips 300 embedded in the first liquid ejecting head 31a, the head chip labeled with a symbol 300z has a cumulative number of times of ejection in the classification “D”, and should be removed. After the head chip 300z to be removed is identified in this manner, the database DB1 related to the already ranked and classified used head chips is accessed, and the initial characteristic values and the like of the used head chips 300 provided in the first liquid ejecting head 31a including the used head chip 300z to be removed are obtained from the database DB1 using a previously read serial number (step S341). The processes above (steps S301 to S341) are the same as those (FIG. 12, steps S101 to S141) in the process of the ranking and classification except for the process (step S331) of removing the head chip 300z. Specifically, in the second embodiment, as part of the later-described selection and assembly step for the used head chip 300, the used head chips 300 included in the first liquid ejecting head 31a are ranked and classified. In this regard, the second embodiment differs from the first embodiment.

Because the ejection performance of the removed used head chip 300z has been identified by the above process, the database DB2 is accessed (step S401), and it is determined whether a used head chip 300 to be substituted for the removed used head chip 300z is present in the ranked and classified inventory (step S411). If a used head chip to be substituted for the used head chip 300z is present in the ranked and classified inventory, the used head chip is selected (step S421). Otherwise, a head chip 310 as a substitute is selected from new head chips (step S431). In the example illustrated in FIG. 17, as a used head chip to be substituted for the removed used head chip 300z, a used head chip 300 is selected which is in the same rank of the initial characteristic value as that of the used head chips 300 other than the removed used head chip 300z, and has a cumulative number of times of ejection less than that of the other used head chips 300, in short, a used head chip in the rank R21 (shown as ejection performance “2A”) is selected.

In such selection of a used head chip 300, the reason why a used head chip 300 in a high rank related to usage history may be that the head chip disposed at its position has a high frequency of use. For example, in FIG. 17, when the used head chip 300 at the left end of the second liquid ejecting head 31y ejects K ink, the position corresponds to the first position L1, and the used head chip disposed at the position corresponds to a “first used head chip”. The used head chips 300 of the second liquid ejecting head 31y, at positions other than the first position eject CMY ink, thus presumably have a lower frequency of ejection than that of the used head chip 300 that ejects K ink. These positions each correspond to the second position L2, and the used head chips 300 disposed at these positions each correspond to a “second used head chip”. The head chip which is disposed at the first position L1 and has a high frequency of ejection does not necessarily eject K ink. For example, when a head chip performs solid printing (solid ejection) having a high rate of operation (duty) using white ink, pre-treatment liquid for prior treatment or post-treatment liquid for an overcoat or the like for treating the medium surface, the head chip has a higher frequency of ejection than other head chips, thus corresponds to a first used head chip.

Subsequently, a selected used head chip 300 or head chip 310 is installed at the location where the used head chip 300z has been removed from the first liquid ejecting head 31a (step S441). As a result, in the liquid ejecting head in which a selected used head chip 300 is embedded, one or a plurality of used head chips 300 to be embedded in the second liquid ejecting head 31y have been selected and embedded among a plurality of used head chips so as to include a plurality of used head chips 300 classified in different ranks, and the second liquid ejecting head 31y has been assembled.

The second liquid ejecting head 31y is returned to the head unit 3a, and the liquid ejecting apparatus 10 is assembled (step S451). As in step S261 of the first embodiment, when the second liquid ejecting head 31y is returned to the head unit 3a, the reading device 65 is connected, and information on the usage history of the head chip (the used head chip 300 or a new head chip 310) installed in substitution for the removed used head chip 300, specifically, data such as the cumulative number of times of ejection is saved in at least one of the memories and 203 (step S461). Subsequently, information on the head chip is registered in the database DB1 in association with the serial number S/N (step S471).

In the registration of the head chip (step S471), when the used head chip 300 is used, its serial number is already registered in the database DB1, thus the data may be overwritten, or may be recorded in existing data as supplement because the head chip has been supplied to the market once. When a new head chip 310 is used, new data of the new head chip is registered in the database DB1. After the above process, “END” is reached, and manufacturing of the liquid ejecting head associated with replacement of the head chip is completed. In the above process, in the first liquid ejecting head 31a, the used head chip 300z unusable as it is continuously is removed, and a new used head chip is embedded along with other used head chips 300, thus the liquid ejecting head as the second liquid ejecting head 31y has been manufactured.

According to the method of manufacturing a liquid ejecting head in the second embodiment described above, the used head chips 300 mounted on a printer or the like once supplied to the market and used are collected, and by utilizing the used head chips ranked and classified based on characteristic information, the used head chip 300 in part of the first liquid ejecting head 31a is removed, and replaced by a head chip in a different rank, thus the second liquid ejecting head 31y can be manufactured. Thus, usable head chips do not need to be discarded uselessly, which can contribute to resource saving. In this process, the used head chips 300 are ranked and classified based on a combination of the initial characteristic value and the cumulative number of times of ejection due to subsequent use, thus desired characteristics of the head chip in the manufactured second liquid ejecting head 31y can be achieved.

With the technique according to the second embodiment, the head chips other than a failed head chip are used as they are, thus only part of the head chips needs to be replaced. Therefore, the number of steps necessary for manufacturing can be reduced. Other operational effects are the same as those in the first embodiment.

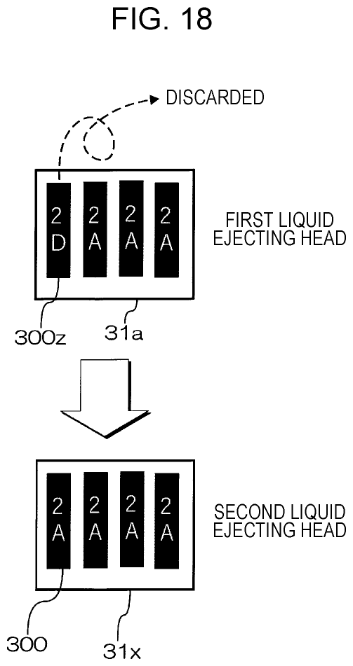

As illustrated in FIG. 18, as the used head chip to be embedded in the second liquid ejecting head 31x, a used head chip 300 (shown as ejection performance “2A”) having a similar degree of deterioration to that of the used head chips 300 other than the removed used head chip 300z may be selected.

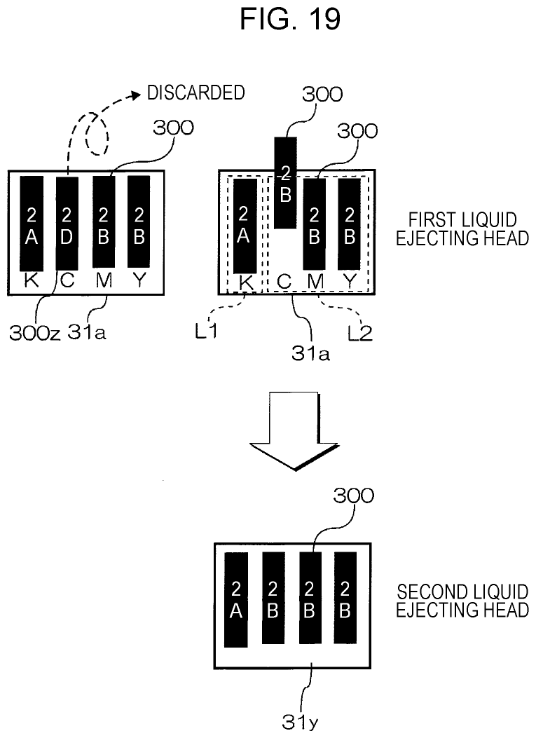

Alternatively, as illustrated in FIG. 19, among the used head chips 300 other than the used head chip 300z removed from the first liquid ejecting head 31a, a used head chip 300 having a higher degree of deterioration or a larger number of times of ejection than that of the used head chip that ejects K ink may be selected. In the example illustrated, the used head chips 300 other than the removed used head chip 300z include used head chips 300 different in the first rank C1 which is the ranking and classification based on the degree of deterioration or the number of times of ejection and the same in the second rank C2 which is the ranking and classification based on the initial characteristic value, specifically, two used head chips 300 in the rank R22 (shown as ejection performance “2B”) and one used head chip 300 in the rank R21 (shown as ejection performance “2A”). Here, the used head chip 300 in the rank R21 is an example of the “first used head chip”, one of two used head chips 300 in the rank R22 is an example of the “second used head chip”, and the used head chip 300z lower in the first rank C1 than the used head chips 300 in the rank R22 is an example of the “third used head chip”. That is, the used head chip 300 embedded in the second liquid ejecting head 31x in the selection step is a used head chip that ejects C ink.

### C. Other Embodiments

(1) In some embodiments above, a description has been given assuming that the manufactured liquid ejecting head is used in a printer; however, the manufacturing method in the present disclosure is applicable to manufacturing of a liquid ejecting head that ejects various types of liquid such as ink, water, alcohol, liquid fuel, and medicinal solution. Ejection of liquid is not necessarily implemented by a technique using a piezoelectric element such as a piezoelectric device, and various methods can be adopted such as a bubble jet method using a heater, and a method using a pump.

(2) In the embodiments above, for the data related to characteristic information, the usage history of a used head chip 300 is read from the memory 200, and the first ranking and classification C1 is performed based on the usage history; however, the used head chip 300 may be removed, and characteristic information may be obtained based on detection of the state of the used head chip 300 by a measurement device, and the first ranking and classification C1 may be performed based on the obtained characteristic information.

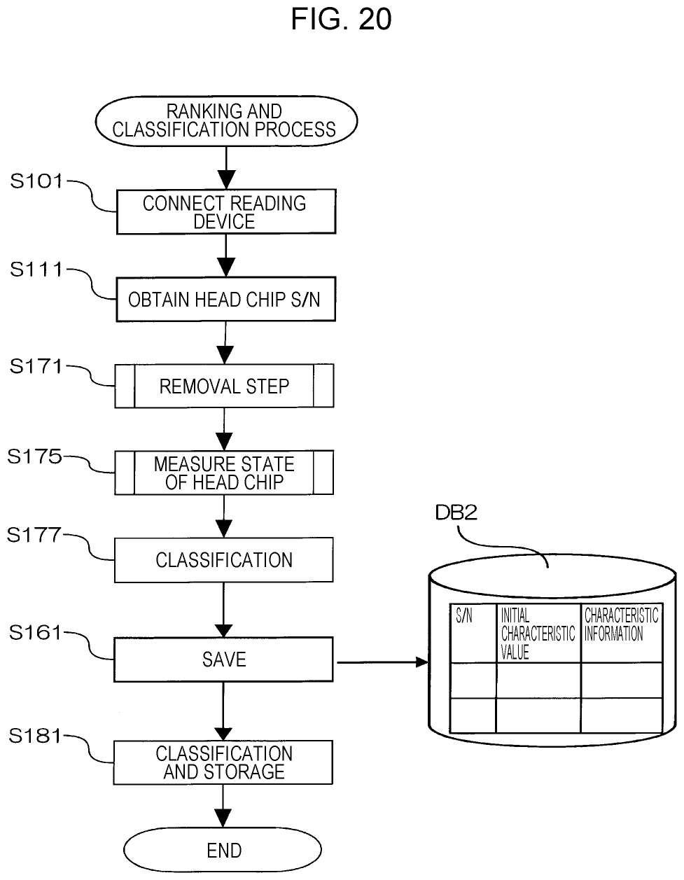

FIG. 20 illustrates an example of process in which the characteristic information of a used head chip is obtained by measurement, and ranked and classified. The ranking and classification step differs from the ranking and classification process illustrated in FIG. 12A in that the removal step (S171) is performed before the ejection performance saving step (S161). The used head chip 300 taken out in the removal step (S171) is attached to a measurement device, and the state of the used head chip 300 is measured (step S175). Subsequently, ranking and classification is performed using the characteristic information obtained based on the measured state of the used head chip 300 (step S177), and in addition, the ranked and classified data of the used head chip 300 is saved (step S161). Note that the used head chip 300 is classified and stored (step S181) in the final stage, this is the same as in the ranking and classification process in the first embodiment.

As described in detail in the first and second embodiments, the characteristic information of the used head chip 300, for example, the ejection performance can be used for the ranking and classification based on the degree of deterioration of the piezoelectric element 60 using parameters such as the initial characteristic value, the cumulative number of times of ejection as the usage history, and the ambient temperature; however, the ranking and classification based on the degree of deterioration of the piezoelectric element 60 is possible using the ejection performance obtained by measuring the displacement amount of the vibration plate 621 as an example of the state of the used head chip 300, for example, by applying a standard drive signal COM to the piezoelectric element 60.

Generally, for prediction of subsequent deterioration of the ejection performance, the initial characteristic value may be considered without depending only on the ejection performance obtained by measurement. Prediction of subsequent deterioration of the ejection performance may be made using the initial characteristic value as well as the usage history of at least one of the cumulative number of times of ejection, the reference voltage Vm of the drive waveform of the drive signal COM, and the ambient temperature. In the above-described embodiment, the degree of deterioration of elements other than the piezoelectric element 60, estimated based on the usage history can be measured similarly. For example, the degree of deterioration of the water repellent film 658 can be detected by measuring the contact angle (wettability) with respect to pure water on the surface of the nozzle plate 650. In other words, the contact angle is an example of the state of the used head chip 300.

(3) In the first embodiment, removing the used head chip 300 from the first liquid ejecting head 31 is performed after obtaining the usage history and the like; however, as described above, when the characteristic information of the used head chip 300 is obtained by measurement, or directly reading from the memory 200 provided in the used head chip by a dedicated reading device prepared, the disassembly step may be performed before reading the usage history.

(4) A semiconductor memory or a magnetic memory can be used as the memory 200 that stores the usage history of the used head chip 300 in the embodiments. As the semiconductor memory, a non-volatile memory may be used which retains data even if the power source is lost, and an EEPROM, a flash memory, or an SRAM backed up by a battery can be used. Note that a memory similar to the memory 200 can be used as the memories 201, 203.

As in the embodiments above, the usage history of the used head chip 300 may be stored in the memory 200 provided in the head chip 310, or the usage history of at least two of the plurality of head chips 310 in one liquid ejecting head 31 may be stored in the memory 201 of the first relay substrate 363 commonly connected to the at least two used head chips 300. In this case, all of the plurality of head chips 310 in the one liquid ejecting head 31 may be connected to the first relay substrate 363, or two of more head chips 310 which are part of the plurality of head chips in the one liquid ejecting head 31 may be commonly connected to the first relay substrate 363. When the usage history of the used head chip 300 is stored in the memory of the first relay substrate 363, the usage history of each used head chip 300 provided in the plurality of first liquid ejecting heads 31 connected to the second relay substrate 335 can be successively read in a collective manner from each memory 201 provided in the first liquid ejecting heads 31 by connecting the reading device 65 to the connector 27b of the second relay substrate 335. Note that the connection cable 63 of the reading device 65 may be connected to the connector 368 of the first relay substrate 363, and in this case, the usage history of a plurality of used head chips 300 included in one first liquid ejecting head 31 can be successively read in a collective manner from each memory 201.

Alternatively, the usage history of each used head chip 300 included in at least two of a plurality of liquid ejecting heads 31 in one head unit 3 may be stored in the memory 203 of the second relay substrate 335 commonly connected to the at least two liquid ejecting heads 31. In this case, all of the plurality of liquid ejecting heads 31 in one head unit 3 may be connected to the second relay substrate 335, or two of more liquid ejecting heads 31 which are part of the plurality of liquid ejecting heads 31 in the one head unit 3 may be connected in common to the second relay substrate 335. When the usage history of the used head chip 300 is stored in the memory 203 of the second relay substrate 335, the usage history of each used head chip 300 provided in the plurality of first liquid ejecting heads 31 connected to the second relay substrate 335 can be successively read in a collective manner from each memory provided in the head unit 3 by connecting the reading device 65 to the connector 27b of the second relay substrate 335.

In the above embodiments, the memory 200 is provided on the flexible wiring substrate 311; however, the memory 200 may be fabricated in an element other than the flexible wiring substrate 311 of the head chip 310, and part or all of a circuit to access the memory 200 may be provided in the flexible wiring substrate 311 or the first relay substrate 363. Furthermore, information related to the usage history may be stored in the memory 203 provided in the second relay substrate 335. In this case, the usage history of each of a plurality of head chips 310 connected to a plurality of liquid ejecting heads 31 connected to the second relay substrate 335 can be collectively or partially collectively read. In addition, the usage history of the used head chip 300 may be stored in two or more of the memories 200, 201, and 203 with data divided. Also, at least part of the data of usage history may be stored redundantly in two or more of the memories 200, 201, and 203 so that the part of the redundant data may be treated as backup data. In the second embodiment described above, when the usage history of each of the plurality of used head chips 300 including the removed used head chip 300z is stored in the memory 201 of the second liquid ejecting head 31, in step S461, only the usage history of the used head chips 300 embedded in the second liquid ejecting head 31 may be overwritten and saved in the memory 201.

(5) In the above-described method of manufacturing a liquid ejecting head, at least part of the following processes is performed:
<1> Manufacturing of a new head chip (step X1).
<2> Embedding a newly produced head chip in a liquid ejecting head (step X2).
<3> Managing data related to characteristic information of the head chip, such as the initial characteristic value of the head chip in association with assignment of a unique ID such as a serial number for the head chip embedded in the liquid ejecting head (step X3).
<4> Collecting a liquid ejecting head with usage history from the market after the liquid ejecting head is supplied to the market (step Y1).
<5> Removing a used head chip from the collected liquid ejecting head (step Y2).
<6> Ranking and classifying the used head chip based on the obtained characteristic information of the used head chip, and managing the used head chip by storing the ranked and classified used head chip with characteristic information associated with information on the ranking and classification (step Y3).
<7> Selecting from the ranked and classified used head chips based on the ranking and classification, and manufacturing a new liquid ejecting head using the selected head chip (step Z1).
<8> Selecting from the ranked and classified used head chips based on the ranking and classification, and manufacturing a liquid ejecting head using the selected head chip along with a used head chip in a specific liquid ejecting head (step Z2).
<9> Providing the ranked and classified used head chip according to a request for the subject of steps Z1, Z2 (step Z3).

Steps X1 to X3 correspond to the process until a new head chip is supplied to the market, steps Y1 to Y3 correspond to the process since a used head chip is collected until it is managed, and steps Z1 to Z3 are related to manufacturing and repairment of a liquid ejecting head using the used head chip. Note that it is possible to consider that steps Y2, Y3 are also related to manufacturing and repairment of a liquid ejecting head using the used head chip. These steps X1 to Z3 may be all performed by the same entity such as a company, or steps X1 to X3, steps Y1 to Y3, and steps Z1 to Z3 may be performed by respective different entities. Generally, all steps may be performed by respective different entities.

(6) In the embodiments above, part of the configuration implemented by hardware may be replaced by software. At least part of the configuration implemented by software can be implemented by a discrete circuit configuration. When part or all of the functions of the present disclosure is implemented by software, the software (computer program) can be provided in a form recorded on a computer-readable recording medium. The “computer-readable recording medium” is not limited to a portable recording medium such as a flexible disk and a CD-ROM, and includes an internal storage in a computer, such as various RAMs and ROMs, and an external storage fixed to a computer, such as a hard disk. In other words, the “computer-readable recording medium” has a broad sense including any recording medium in which data packet can be stored in a non-volatile manner.

(7) In the embodiments above, the liquid ejecting apparatus 10 includes the head unit 3 including a plurality of liquid ejecting heads 31, but this is not always the case. The liquid ejecting apparatus 10 may have one liquid ejecting head 31, in other words, may not have a head unit 3.

(8) In the embodiments above, the second ranking and classification C2 based on the initial characteristic value may not be performed, and selecting a used head chip to be embedded in the second liquid ejecting head 31 may be performed based on the first ranking and classification C1 in which the used head chip 300 is classified in a plurality of ranks based on at least one of the degree of deterioration of the piezoelectric element 60, the degree of deterioration of the adhesive, and the degree of deterioration of the water repellent film 658.

(9) In the second embodiment, as illustrated in FIGS. 17 to 19, in the assembly step, the number of used head chips 300 to be embedded in the second liquid ejecting head 31, in other words, the number of used head chips 300 selected in the selection step as the used head chips 300 to be embedded in the second liquid ejecting head 31 is one, but may be plural.

(10) One of the following methods may be adopted to obtain the usage history of a used head chip 300.
The usage history of a used head chip 300 of a liquid ejecting head 31 at a sales or lease site (hereinafter may be referred to as a customer site) may be obtained from a printer connected to the Internet at the customer site through a network if the printer can access a memory that holds the usage history.
Data related to the usage history may be stored in a memory of a substrate included in a printer at a customer site. For example, a worker who collects the first liquid ejecting head 31 obtains data of usage history using an electronic device that, upon being connected to a printer at a customer site, can read the data of usage history from the printer and save the data, and the data of usage history is transmitted by a wire or wirelessly from the electronic device to the server of a company that conducts the recycle process RCL.

(11) In the embodiments above, the data related to usage history may be usage history itself or information correlated with usage history. For example, information related to the reference voltage Vm of the drive waveform of the drive signal COM, as an example of usage history may be the reference voltage Vm itself, or may be the intermediate potential Vc of the drive signal COM and the reference potential Vbs of the reference voltage signal because the reference voltage Vm can be calculated from the intermediate potential Vc and the reference potential Vbs.

The present disclosure is not limited to the above-described embodiments, and may be implemented in various configurations in a range not departing from the gist of the present disclosure. For example, the technical features in the embodiments corresponding to the technical features in the form described in the paragraph of SUMMARY can be replaced, or combined as needed to cope with part or all of the above-mentioned problems or to achieve part or all of the above-mentioned effects. In addition, when the technical features are not described as essential ones in the present specification, those technical features can be deleted as needed.

What is claimed is:

1. A method of manufacturing a liquid ejecting head for manufacturing a second liquid ejecting head by recycling part of a plurality of used head chips included in one or a plurality of first liquid ejecting heads, the method comprising:
first ranking and classifying the plurality of used head chips included in the one or a plurality of first liquid ejecting heads into a plurality of ranks based on characteristic information of each of the plurality of used head chips included in the one or a plurality of first liquid ejecting heads;
selecting one or a plurality of used head chips to be embedded in the second liquid ejecting head among the plurality of used head chips so that the second liquid ejecting head includes a plurality of used head chips classified in different ranks in the first ranking and classifying; and
embedding the one or a plurality of the used head chips selected in the selecting into the second liquid ejecting head.

2. The method of manufacturing a liquid ejecting head according to claim 1, further comprising a second ranking and classifying the plurality of used head chips included in the one or a plurality of first liquid ejecting heads into a plurality of ranks based on an initial characteristic value of each of the plurality of used head chips,
wherein in the selecting, the one or a plurality of used head chips to be embedded in the second liquid ejecting head are selected so that the plurality of used head chips included in the second liquid ejecting head includes only the plurality of used head chips classified in a same rank in the second ranking and classifying.

3. The method of manufacturing a liquid ejecting head according to claim 1,
wherein in the selecting, all of the used head chips included in the second liquid ejecting head to be embedded in the second liquid ejecting head are selected so that the plurality of used head chips included in the second liquid ejecting head include the plurality of used head chips classified in different ranks in the first ranking and classifying.

4. The method of manufacturing a liquid ejecting head according to claim 1,
in the selecting, the one or a plurality of used head chips to be embedded in the second liquid ejecting head are selected as part of all of the used head chips included in the second liquid ejecting head so that the plurality of used head chips included in the second liquid ejecting head include the plurality of used head chips classified in different ranks in the first ranking and classifying.

5. The method of manufacturing a liquid ejecting head according to claim 4,
wherein the plurality of used head chips of the second liquid ejecting head include a first used head chip, and
a second used head chip classified into a rank that is higher in degree of deterioration or greater in number of times of ejection than a rank of the first used head chip in the first ranking and classifying,
the method includes removing, from the first liquid ejecting head, a third used head chip classified into a rank that is higher in degree of deterioration or greater in number of times of ejection than a rank of the second used head chip in the first ranking and classifying, and
in the selecting, the first used head chip is selected as the one or a plurality of used head chips to be embedded in the second liquid ejecting head.

6. The method of manufacturing a liquid ejecting head according to claim 4,
wherein the plurality of used head chips of the second liquid ejecting head include a first used head chip, and
a second used head chip classified into a rank that is higher in degree of deterioration or greater in number of times of ejection than a rank of the first used head chip in the first ranking and classifying,
the method includes removing, from the first liquid ejecting head, a third used head chip classified into a rank that is higher in degree of deterioration or greater in number of times of ejection than a rank of the second used head chip in the first ranking and classifying, and
in the selecting, the second used head chip is selected as the one or a plurality of used head chips to be embedded in the second liquid ejecting head.

7. The method of manufacturing a liquid ejecting head according to claim 1,
wherein one of the plurality of ranks classified in the first ranking and classifying is a non-recyclable rank for classifying as a used head chip exceeding a usage limit.

8. The method of manufacturing a liquid ejecting head according to claim 1,
wherein the plurality of used head chips of the second liquid ejecting head include a first used head chip disposed at a first position of the second liquid ejecting head, and a second used head chip disposed at a second position of the second liquid ejecting head,
a frequency of ejection of the first used head chip disposed at the first position of the second liquid ejecting head is higher than a frequency of ejection of the second used head chip disposed at the second position of the second liquid ejecting head, and
in the first ranking and classifying, the first used head chip is classified in a rank that is lower in degree of deterioration or smaller in volume of information related to a number of times of ejection than a rank to which the second used head chip belongs.

9. The method of manufacturing a liquid ejecting head according to claim 1,
wherein the characteristic information is obtained based on usage history of the plurality of used head chips.

10. The method of manufacturing a liquid ejecting head according to claim 9,
wherein the usage history includes information related to a number of times of ejection of liquid through nozzles of the plurality of used head chips.

11. The method of manufacturing a liquid ejecting head according to claim 10,
wherein the usage history further includes at least one of information related to a reference voltage of a drive waveform applied to the used head chips or information related to an ambient temperature when the used head chips are used.

12. The method of manufacturing a liquid ejecting head according to claim 9,
wherein the usage history includes at least one of [1] information related to a number of times of wiping performed on a nozzle surface of the used head chips; [2] information related to a number of times of a cleaning process performed on the used head chips; [3] information related to an elapsed time since liquid is filled in the used head chips; or [4] information related to a type of liquid supplied into the used head chips.

13. The method of manufacturing a liquid ejecting head according to claim 1,
wherein the characteristic information is obtained based on detection of a state of the used head chips.

14. The method of manufacturing a liquid ejecting head according to claim 1, further comprising
removing the used head chips from the first liquid ejecting heads.
